(19) United States
(12) Patent Application Publication
(10) Pub. No.: US 2022/0270296 A1
(43) Pub. Date: Aug. 25, 2022

(54) METHOD FOR PROCESSING IMAGE, MOBILE ROBOT AND METHOD FOR CONTROLLING MOBILE ROBOT

(71) Applicant: SHANGHAI ANKOBOT ROBOT CO., LTD, Shanghai (CN)

(72) Inventor: Zhijian HE, Shanghai (CN)

(21) Appl. No.: 17/542,083

(22) Filed: Dec. 3, 2021

(30) Foreign Application Priority Data
Feb. 23, 2021 (CN) CN202120396502.6
Feb. 25, 2021 (CN) CN202110209422.X
Mar. 8, 2021 (CN) CN202110249501.3
Mar. 8, 2021 (CN) CN202110249565.3

(51) Int. Cl. G06T 7/00; G06T 5/00; G06T 7/10; G06T 3/40; H04N 5/235; H04N 5/225; G05D 1/02

(52) U.S. Cl. CPC G06T 7/97; G06T 5/007; G06T 7/10; G06T 5/002; G06T 3/40; H04N 5/2352; H04N 5/2254; H04N 5/2256; G05D 1/0231; G06T 2207/10144

(57) ABSTRACT

The present application discloses an image processing method, an image acquisition assembly, a mobile robot, and a control method and system thereof. The image processing method is used in an image acquisition assembly provided on a mobile robot. The image processing method includes: capturing an image frame sequence; based on the image frame sequence, sequentially outputting corresponding image frame for use in at least one functional mode of the mobile robot, wherein a frame rate of the output image frame for use in the same functional mode is set based on a frame rate requirement of each functional mode for image. The present application utilizes images with different frame rates provided by the image acquisition assembly to operate in multiple functional modes; and optimally configures image frame sequences provided by the image acquisition assembly to deal with contradictions with frame rate requirements for image data in different functional modes.

### RELATED APPLICATIONS

This present application claims the priority to Chinese Patent Application No.: 202120396502.6, filed Feb. 23, 2021, Chinese Patent Application No.: 202110209422.X, filed Feb. 25, 2021, Chinese Patent Application No.: 202110249501.3, filed Mar. 8, 2021, and Chinese Patent Application No.: 202110249565.3, filed Mar. 8, 2021, the content of which are hereby incorporated herein by reference in their entirety.

### TECHNICAL FIELD

The present application relates to the field of mobile robots, in particular to an image processing method, an image acquisition assembly, a mobile robot and a control method and system thereof.

### BACKGROUND

A mobile robot performs autonomous movement operations based on navigation control technology. Subject to a scene where the mobile robot is applied, when the mobile robot is in an unknown location in an unknown environment, VSLAM (Visual Simultaneous Localization and Mapping) technology or SLAM (Simultaneous Localization and Mapping) technology or the like is used to perform a navigation operation and build a map.

When a mobile robot such as a cleaning robot, an accompanying robot or a greeter robot moves in a working mode, various environmental detection devices are usually provided on the mobile robot because of the complexity of the working environment, and each environmental detection device is adapted to objects hindering autonomous movement that may be encountered in the working scene. With continuous research on working scenes, various environmental detection devices configured for a mobile robot can provide detection data of overlapping areas. The detection data is difficult to fuse for use due to different types of the data provided by the environmental detection devices. As a result, a control system of the mobile robot becomes redundant and complex.

### SUMMARY

In view of the above-mentioned shortcomings of related art, an object of the present application is providing an image processing method, an image acquisition assembly, a mobile robot and a control method and system thereof, to solve the problem that the information reflected by different types of environmental detection data of a mobile robot overlaps and is not easy to reuse, leading to high complexity of a data processing process.

To achieve the above object and other relevant objects, a first aspect of the present application provides an image processing method used in an image acquisition assembly provided on a mobile robot, the image processing method including: capturing an image frame sequence; and based on the image frame sequence, sequentially outputting corresponding image frame for use in at least one functional mode of the mobile robot, wherein a frame rate of the output image frame for use in the same functional mode is set based on a frame rate requirement of each functional mode for image.

A second aspect of the present application provides a visual control device, including: a control unit configured to connect a vision acquisition device to control the vision acquisition device to capture an image frame sequence; and an image processing unit connected with the vision acquisition device, configured to, based on the image frame sequence, sequentially output corresponding image frames for use in at least one functional mode of a mobile robot, wherein a frame rate of the output image frame for use in the same functional mode is set based on a frame rate requirement of each functional mode for image.

A third aspect of the present application provides an image acquisition assembly, which is applied to a mobile robot, the image acquisition assembly including: a vision acquisition device configured to capture images; a control unit connected with the vision acquisition device and configured to control the vision acquisition device so that the images captured by the vision acquisition device are output in an image frame sequence; and an image processing unit connected with the vision acquisition device and configured to, based on the image frame sequence, sequentially output corresponding image frames for use in at least one functional mode of a mobile robot, wherein a frame rate of the output image frame for use in the same functional mode is set based on a frame rate requirement of each functional mode for image.

A fourth aspect of the present application provides a control method of a mobile robot, including the following steps: correspondingly distributing received image frames to a corresponding functional mode for use, wherein the image frames are output by an image acquisition assembly performing the image processing method in the first aspect, or by the visual control device in the second aspect, or by the image acquisition assembly in the third aspect; and correspondingly executing the corresponding functional mode based on the image frames so that the mobile robot works according to the corresponding functional mode.

A fifth aspect of the present application provides a control system of a mobile robot, the mobile robot including an image acquisition assembly, the control system including: an interface device configured to distribute received image frames to a corresponding functional mode for use; a memory configured to store at least one program; and a processor connected with the interface device and the memory device, configured to, when calling and executing the at least one program, coordinate the interface device, the memory device and the image acquisition assembly to execute and implement the control method in the fourth aspect.

A sixth aspect of the present application provides a mobile robot, inducing: the image acquisition assembly in the third aspect; a movement device configured to take, in a controlled manner, the mobile robot to work in a corresponding functional mode; a memory configured to store the acquired image frame sequence and at least one program; and a processor configured to invoke the at least one program to execute the control method in the fourth aspect.

A seventh aspect of the present application provides a computer readable storage medium storing at least one program which, when being invoked, executes the image processing method in the first aspect, or the control method in the fourth aspect.

In summary, in the present application, time series processing is performed on the images in the first image frame sequence to obtain a second image frame sequence that meets the frame rate requirement in at least one functional mode, and the second image frame sequence can be allocated by the control system to the corresponding functional mode, and the functional modes are run to obtain information inputs about changes in the surrounding environment during the movement of the mobile robot from the corresponding images, such as obtaining information related to position changes such as localization features, obstacle information, and charging pile information from the images of the corresponding frame rate, so that the control system chooses to perform the movement behavior in one of the functional modes based on the obtained information. The present application utilizes images with different frame rates provided by the image acquisition assembly to operate in multiple functional modes; and optimally configures image frame sequences provided by the image acquisition assembly to deal with contradictions with frame rate requirements for image data in different functional modes.

### BRIEF DESCRIPTION OF THE DRAWINGS

Specific features of the disclosure involved in the present application are shown in the appended claims. Characteristics and advantages of the disclosure involved in the present application can be better understood by reference to the exemplary embodiments and accompanying drawings described in detail below. Brief description of the drawings is as follows:

FIG. 1 shows a schematic diagram of a mobile robot in the related art.

FIG. 2 shows a structure diagram of a mobile robot of the present application in an embodiment.

FIG. 3 shows a position diagram of a camera and a housing.

FIG. 4 shows a side view of the mobile robot of the present application in an embodiment.

FIG. 5 shows a top view of the mobile robot of the present application in an embodiment.

FIG. 6 shows a structure diagram of an image acquisition assembly in the mobile robot of the present application in an embodiment.

FIG. 7 shows an enlarged diagram at A to in FIG. 6.

FIG. 8 shows an exploded diagram of a camera module in FIG. 6 in an embodiment.

FIG. 9 shows a structure block diagram of the image acquisition assembly.

FIG. 10 shows another structure block diagram of the image acquisition assembly.

FIG. 11 shows a flow diagram of an image processing method of the image acquisition assembly.

FIG. 12 shows a flow diagram of the image acquisition assembly in an embodiment.

FIG. 13 shows a schematic diagram of a second image frame sequence.

FIG. 14, which shows a flow diagram of the image acquisition assembly in another embodiment.

FIG. 15 shows a schematic diagram of an area of interest corresponding to an obstacle avoidance mode in an image.

FIG. 16 shows a schematic diagram of weight distribution of an area of interest of a functional mode corresponding to an image.

FIG. 17 shows a schematic diagram of a ground image area and an above-ground image area in an image.

FIG. 18 shows a structural block diagram of a control system.

FIG. 19 shows a schematic flow diagram of a control method executed by the control system.

FIG. 20 shows a flow diagram of a control method executed by the control system.

FIGS. 21A and 21B respectively shown the same object corresponding to different image positions in two frames of images when the mobile robot turns right.

FIG. 22 shows a bottom-view diagram of the mobile robot in an embodiment.

### DETAILED DESCRIPTION

Embodiments of the present application will be described below with specific examples, and other advantages and effects of the present application will be readily apparent to those skilled in the art from the disclosure in the specification.

In the following description, please refer to the drawings, which illustrate a number of embodiments of the present application. It should be understood that other embodiments may also be used, and mechanical compositional, structural, electrical, and operational changes can be made without departing from the spirit and scope of the present disclosure. The following detailed description should not be regarded as restrictive, and the scope of the embodiments of the present application is defined only by the claims of the disclosed patent. Terms as used herein are only used for describing the specific embodiments, and are not intended to limit the present application. Space-related terms, such as “upper”, “lower”, “left”, “right”, “under”, “below”, “lower part”, “above”, and “upper part”, may be used herein to describe a relationship between one element or feature and another element or feature shown in a figure.

Although the terms first, second, etc. are used herein to describe various elements or parameters in some examples, the elements or parameters should not be limited by the terms. The terms are only used to distinguish one element or parameter from another element or parameter. For example, a first image frame sequence may be referred to as a second image frame sequence, and similarly, a second image frame sequence may be referred to as a first image frame sequence, without departing from the scope of various described embodiments. Each of the first image frame sequence and the second image frame sequence is used to describe an image frame sequence, but they are not a same image frame sequence unless the context explicitly indicates otherwise.

Furthermore, as used herein, the singular forms “a”, “an” and “the” are also intended to encompass plural forms, unless indicated to the contrary in the context. It should be further understood that the terms “include” and “comprise” denote the existence of the described feature, step, operation, element, component, item, category, and/or group, but do not exclude the existence, presence or addition of one or more other features, steps, operations, elements, components, items, categories, and/or groups. The terms “or” and “and/or” as used herein are to be interpreted as inclusive or meaning any one or any combination. Therefore, “A, B or C” or “A, B and/or C” means “any of the following: A; B; C; A and B; A and C; B and C; A, B and C”. An exception to this definition will occur only when a combination of elements, functions, steps or operations is inherently mutually exclusive in some way.

A mobile robot is a machine that automatically performs a specific job. It can accept a person's command, run pre-written programs, or act according to principles and guidelines formulated with artificial intelligence technology. Such mobile robots can be used indoors or outdoors, in industry or at home, can replace a security guard for an inspection tour, or replace a person for cleaning the ground, and can also be used for family companion, office assistance or the like. Using the most common cleaning robot as an example, a cleaning robot, including a sweeping robot, a mopping robot or a sweeping and mopping integrated robot, is a type of intelligent household appliance that can perform sweeping, dust collection, floor mopping work. Specifically, the cleaning robot can perform a ground cleaning task in the room by itself under the control of a person (an operator holding a remote control or using an APP on an intelligent terminal) or autonomously according to certain set rules. It can clear away debris on the ground such as hair, dust, and scraps.

To achieve autonomy of the cleaning robot, the cleaning robot needs the ability to autonomously explore the surrounding environment, build a reliable environmental map, and locate itself in the map. Currently, applications of the visual simultaneous localization and mapping (VSLAM) or visual localization and mapping technology in cleaning robots have achieved good results.

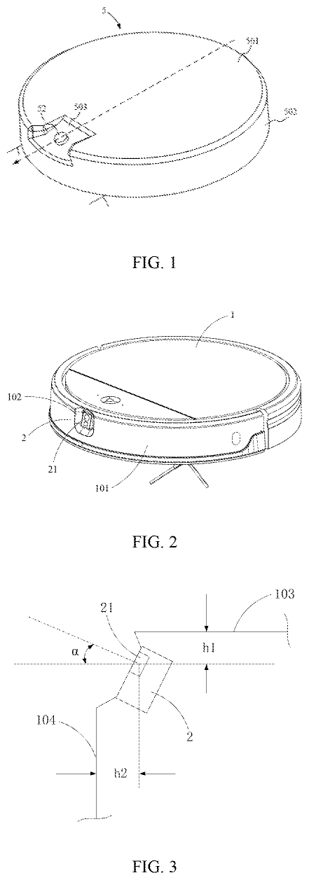

To solve a visual range problem of a monocular vision solution to improve the precision and reliability of VSLAM, the applicant has proposed improved designs, such as that illustrated in the patent document with Chinese Patent Publication No. CN207424680U. As shown in FIG. 1, which illustrates a schematic diagram of a mobile robot in the related art, the mobile robot 5 disclosed in the patent document is equipped with a front-end image acquisition assembly 52. The front-end image acquisition assembly 52 is arranged in a front-end recessed structure 503 adjacent to the intersection of a top surface 501 and a side surface 502 of a robot housing, which enables the front-end image acquisition assembly 52 to have a wider photographic viewing angle (an included angle between a lens optical axis in the front-end image acquisition assembly 52 and a plane defined by the top surface 501 of the housing is 61° to 85°) than an image acquisition assembly in the related art arranged on a top surface of a mobile robot, to obtain image data with more information, and obtain a more accurate distance measurement and determine the position and attitude of the mobile robot by using the image data of the front-end image acquisition assembly, thereby improving the precision and reliability of the visual simultaneous localization and mapping.

Although a wider photographic viewing angle is achieved in this solution by providing the front-end image acquisition assembly at the intersection of the top surface and the side surface, however, the photographic viewing angle is still limited. As shown in FIG. 1, the included angle between the lens optical axis in the front-end image acquisition assembly 52 and the plane defined by the top surface 501 of the housing is 61° to 85°, and the field of view of the front-end image acquisition assembly 52 is still limited to an area in the upper part in front thereof, such as the ceiling. Although it can perform localization and build a map by using image features of the ceiling or an area above a part directly in front thereof, its field of view is limited due to the setting of the angle of the image acquisition assembly in the solution provided by CN207424680U, so it cannot obtain image information of an area directly in front thereof, especially the ground on the lower side, and thus its obstacle avoidance effect is not good when a visual solution is used alone.

As the viewing angle is limited, and scenes of at least one of the following aspects are usually considered during autonomous movement of the mobile robot: localization and navigation, obstacle avoidance, and fall prevention, the mobile robot needs to acquire more data in its forward movement direction and needs to be equipped with various environmental detection devices. Usually, the sensors for implementing an obstacle avoidance function, such as an ultrasonic sensor, an infrared sensor, a photoelectric switch sensor, and a ToF sensor, are arranged on a buffer assembly (also called a bumper) of the mobile robot. The buffer assembly is, for example, of a structure of a buffer assembly illustrated in Chinese patent document with patent publication No. CN210277064U. However, the structure of the buffer assembly occupies a large amount of layout space of the cleaning robot, which increases the design difficulty and leads to a complex mechanical structure and an increase in material cost and manufacturing cost. Moreover, data processing and technology fusion of multiple sensors or multiple types of sensors also greatly increase the design difficulty and product cost.

Furthermore, as a mobile robot becomes more sophisticated in implementing autonomous movement in working scenes, the mobile robot is equipped with more types of environmental detection devices. This leads to an increasing number of environmental detection devices arranged on the mobile robot, and different types of data provided by the devices may cover same environmental areas. For example, a laser ranging device and an image acquisition assembly have an overlapped area of field of view, etc. In other words, a control system of the mobile robot may perform redundant data processing (e.g., data processing for obstacle avoidance or localization) using different types of data from the same area of field of view, resulting in an increasing data processing amount.

However, reducing the environmental detection devices (also known as sensor assemblies) produces new problems. For example, an image acquisition assembly alone can provide image data (also called image frames, images) for navigating the movement. However, when the image data is used for obstacle avoidance control, a misoperation of the mobile robot may occur due to unavailability of depth data. For example, a pattern on the ground (such as a carpet pattern) is incorrectly recognized as an obstacle, and a detouring movement is performed, etc. This misoperation not only may leads to failure of the mobile robot to navigate to a target location, but is also unfavorable for the mobile robot to perform other operations synchronously during autonomous movement, such as reducing the cleaning coverage of a sweeping operation/mopping operation.

It needs to reduce redundant data detected by the mobile robot on the one hand, and to address the problem that the mobile robot cannot provide required input information for different behaviors at the same time after data reduction on the other hand. For example, an autonomous movement behavior of the mobile robot in a navigation route requires stable localization data, and a behavior of braking or turning in time for obstacle avoidance requires image data of obstacles on the ground and their relative positions. The stable localization data usually comes from a space with few complex changes in a physical space, while the image data of the obstacles and their relative positions required for obstacle avoidance come from the navigation route of the mobile robot.

To obtain the input information that can be used by the mobile robot to perform different behaviors, the present application provides a mobile robot equipped with an image acquisition assembly. The image acquisition assembly is arranged on a body of the mobile robot, and an optical axis of a camera in the image acquisition assembly is arranged in a tilted upward direction, and the angle and field of view of the camera are set so that the camera can have a wider photographic viewing angle and obtain image data with more information and the mis operation camera device can be applied to various functional modes. Compared with the existing related art, this simplifies the structure, can omit corresponding sensor components, and greatly saves manufacturing and design costs. In other words, the solution provided in the present application aims to implement various functional modes of the mobile robot, such as localization and mapping, navigation, obstacle avoidance, visual tracking, and return to a charging pile, by using a monocular vision solution. The division of the functional modes is based on different processing by the control system using information provided by images to produce different output data.

In embodiments, the functional modes are used to help the mobile robot perform intelligent operations, such as autonomous movement, in complex environments. For example, the functional modes include at least one of: a navigation mode including a navigational movement operation, a mapping mode including a movement operation for building a map (also known as a visual localization and mapping mode, or VSLAM mode), an obstacle avoidance mode including a movement operation for avoiding an obstacle (also known as an ODOA (Obstacle Detection Obstacle Avoidance) mode), a transfer mode including a movement operation for pushing/pulling a target object, and a docking mode including a visual docking operation (also known as v-docking (visual docking) mode). The functional modes also include modes set to improve intelligent operations of the mobile robot, such as including a visual scene understanding mode executed to mark semantics in a map (also known as a VSU (Visual Scene Understanding) mode), and/or including a visual tracking mode executed to improve image processing efficiency (also known as a VO (Visual Odometry) mode).

The mobile robot of the present application is described in detail in conjunction with the accompanying drawings. To describe the assembly position of the image acquisition assembly and the role of images captured by the image acquisition assembly in information input of a plurality of functional modes, the mobile robot in some figures of the present application is exemplified by a cleaning robot.

Please refer to FIG. 2, which shows a structure diagram of a mobile robot of the present application in an embodiment. The mobile robot of the present application includes a camera device. Limited by the overall height requirement of the cleaning robot, the image acquisition assembly 2 is arranged at the intersection of a top surface and a side surface of a front end of a housing. In other mobile robot examples, the image acquisition assembly 2 is arranged at other positions of the mobile robot, and an included angle between its optical axis and a plane of movement meets the requirement that input information can be provided for various functional modes.

For ease of understanding and clarity of presentation, in embodiments of the present application, for the mobile robot, a direction in which a movement device drives a robot body 1 to move forward is defined as a front direction; and correspondingly, an opposite direction to the direction in which the robot body 1 moves forward is defined as rear direction. It should be understood that a side of the robot body 1 in the direction in which the robot body 1 advances is defined as a front side; and a side of the robot body 1 in the opposite direction away from the front side is defined as a rear side.

Generally, the robot body 1 has a housing and a chassis. The housing may include a top surface and a side surface, such that the housing formed by the top surface, the side surface and the chassis has an accommodating space of a certain size. The housing in the mobile robot shown in FIG. 2 may be, for example, of a flat cylindrical structure. The housing of the flat cylindrical structure includes a disc-shaped top surface and a side surface connected to the outer circumference of the top surface. When the mobile robot moves (the movement includes at least one combination of forward movement, backward movement, steering, and rotation), the housing of the flat cylindrical structure has better environmental adaptability. For example, during movement, it reduces the probability of collision with surrounding objects (such as furniture and walls) or reduce the intensity of collision to reduce damage to the mobile robot itself and the surrounding objects, which is more conducive to steering or rotation. However, the present application is not limited thereto. In other embodiments, the housing of the mobile robot may also be of a rectangular body structure, a triangular column structure, or a semi-elliptical column structure (also called a D-shaped structure), etc.

The chassis may be integrally formed by a material such as plastic, and includes a plurality of pre-formed grooves, recesses, clamping slots, or similar structures for mounting or integrating related devices or components on the chassis. In some embodiments, the housing may also be integrally formed by a material such as plastic, and is configured to complement the chassis and can provide protection for devices or components mounted to the chassis. The top surface of the housing may also be provided with other devices. For example, in some embodiments, a pickup may be provided on the top surface of the housing to acquire ambient sounds from the mobile robot during a cleaning operation or a voice command from a user. In some embodiments, a microphone may be provided on the top surface of the housing to play voice messages. In some embodiments, a touch display screen may be provided on the top surface of the housing to achieve a good human-machine experience.

The chassis and the housing may be removably combined together by various suitable devices (e.g., screws, clamping buckles, etc.), and after being combined, the chassis and housing form an internal space. The internal space may be used to accommodate various devices or components of the mobile robot. For example, the internal space may be used to accommodate a power supply device, a cleaning device, a control system, and other related devices or components.

The image acquisition assembly 2 includes a camera 21 (also called a vision acquisition device), and an optical axis of the camera 21 is arranged in a tilted upward direction. In this way, the camera can have a wider photographic viewing angle and obtain image data with more information and can be applied to various functional modes.

In some embodiments, the mobile robot is also provided with a recessed structure 102 at the intersection of the top surface and side surface at the front end of the housing, and the image acquisition assembly 2 is arranged in the recessed structure 102, and the recessed structure 102 is provided with an opening plane corresponding to the image acquisition assembly 2. The recessed structure may be a transition structure of the top surface of the housing towards the side surface at the front end thereof. The transition structure may be, for example, a recess or an inclined surface.

In some embodiments, in the case a buffer assembly 101 (for example, a bumper) is provided on a front side of the robot body 1, a front end of the buffer assembly 101 is provided with a recessed structure, and the image acquisition assembly 2 is arranged in the recessed structure 102, and the recessed structure 102 is provided with an opening plane corresponding to the image acquisition assembly 2. The recessed structure may be a transition structure of a top surface of the buffer assembly 101 towards a side surface of a front end thereof. The transition structure may be, for example, a recess or an inclined surface.

As previously described, arranging the image acquisition assembly 2 in the recessed structure 102 can protect the camera in the image acquisition assembly. The camera of the image acquisition assembly 2 is spaced from both the top surface and the side surface of the robot body 1.

Please refer to FIG. 3, which shows a position diagram of the camera and the housing. A distance h1 between the camera 21 in the image acquisition assembly 2 and the top surface 103 of the housing is 3 mm to 10 mm, and a distance h2 between the camera 21 and the side surface 104 at the front end of the housing is 3 mm to 10 mm. In addition, the distance h1 between the camera in the image acquisition assembly 2 and the top surface 103 of the housing and the distance h2 between the lens and the side surface 104 at the front end of the housing in the above description may be varied in different combinations depending on the construction of the mobile robot and the application environment. For example, in some implementations, the distance h1 between the camera 21 and the top surface 103 of the housing and the distance h2 between the camera 21 and the side surface 104 at the front end of the housing may have the same value which is relatively small (e.g., h1=h2=3 mm, h1=h2=4 mm, or h1=h2=5 mm), such that the image acquisition assembly 2 is relatively closer to the combined upper edge of the combined housing and has a better photographic viewing angle. In some implementations, the distance h1 between the camera 21 and the top surface 103 of the housing and the distance h2 between the camera 21 and the side surface 104 at the front end of the housing may have the same value which is relatively large (e.g., h1=h2=8 mm, h1=h2=9 mm, or h1=h2=10 mm), such that the image acquisition assembly 2 is relatively farther from the upper edge of the housing, which can achieve better protection of the image acquisition assembly 2. In some implementations, the distance h1 between the camera 21 and the top surface 103 of the housing and the distance h2 between the lens and the side surface 104 at the front end of the housing may have different values. For example, the mobile robot mainly moves on the ground, and the side surface 104 of the housing is more likely to interfere and collide with surrounding objects than the top surface 103 during the movement of the mobile robot. Therefore, to protect the image acquisition assembly 2, the distance h2 between the camera 21 in the image acquisition assembly 2 and the side surface 104 at the front end of the housing may be set larger than the distance h1 between the camera 21 and the top surface 103 of the housing. However, the present application is not limited thereto. In some implementations, the distance h1 between the camera 21 in the image acquisition assembly 2 and the top surface 103 of the housing may be set larger than the distance h2 between the camera 21 and the side surface 104 at the front end of the housing. It is to be noted that those skilled in the art should understand that the values of the distance h1 between the camera in the image acquisition assembly 2 and the top surface 103 of the housing and the distance h2 between the lens and the side surface 104 at the front end of the housing in the above description are integers, but the value precision is not limited to 1 mm. According to the actual design requirement of the mobile robot, the precision of the distance values may be higher, such as up to 0.5 mm. Examples are not exhausted here. In addition, the distance h1 between the camera 21 in the image acquisition assembly 2 and the top surface 103 of the housing being in the range of 3 mm to 10 mm, and the distance h2 between the camera 21 and the side surface 104 at the front end of the housing being in the range of 3 mm to 10 mm in the above description is only exemplary description. According to the design requirement of the mobile robot, the e.g., value of the distance h1 may also be smaller than 3 mm or greater than 10 mm, and the e.g., value of the distance h2 may also be smaller than 3 mm or greater than 10 mm. Examples are not exhausted here. By arranging the image acquisition assembly 2 in the recessed structure 102 at the front end, the camera in the image acquisition assembly 2 is not exposed from the top surface and the side surface of the housing. In this way, the image acquisition assembly 2 is not touched by surrounding objects when the mobile robot moves. For example, in a scenario the mobile robot moves forward and travels under a sofa, a bed, a tea table or the like, or when it collides with a wall, a clamp or a table leg, the image acquisition assembly 2 is not touched by these surrounding objects, and the image acquisition assembly 2 is protected from damage.

The image acquisition assembly 2 is provided on the mobile robot and can be used to capture images of the operating environment of the mobile robot and applied accordingly to provide input information for various functional modes.

In some implementations, the camera in the image acquisition assembly 2 may, for example, be of a forward-tilted design, i.e., the optical axis of the camera is arranged in a tilted upward direction to capture more environmental information.

Referring further to FIG. 3, an included angle α between the optical axis of the camera 21 in the image acquisition assembly 2 and the forward movement direction of the mobile robot is 12° to 15°, i.e., an included angle α between the optical axis of the camera and a horizontal plane in which the forward movement direction of the mobile robot is located is 12° to 15°. In different embodiments, the included angle α may be 12.0°, 12.5°, 13.0°, 13.5°, 14.0°, 14.5°, 15.0°, or the like. It is to be noted that those skilled in the art should understood that the value of the included angle between the optical axis and the forward movement direction of the mobile robot is an integer in the above description, but the precision of the included angle α is not limited to 1°. According to the actual design requirement of the mobile robot, the precision of the included angle may be higher, such as up to 0.1°, 0.01° or more. Of course, the e.g., above-mentioned included angle α may be any angle in the above-mentioned range between 12° and 15°. For example, it may be 12.1°, 12.2°, 12.3°, 12.4°, 12.6°, 12.7°, 12.8°, 12.9°, or the like. In some embodiments, a plane defined by the top surface of the housing may be aligned with a horizontal plane, which means that when the mobile robot is placed stably on a horizontal plane, the plane defined by the top surface of the housing is parallel to the horizontal plane.

In addition, the camera 21 has a focal length of 8 cm to 12 cm. In different embodiments, the focal length may be 8.0 cm, 8.5 cm, 9.0 cm, 9.5 cm, 10.0 cm, 10.5 cm, 11.0 cm, 11.5 cm, 12.0 cm, or the like. Of course, the above-mentioned focal length may have any value in the above-mentioned range between the 8 cm and 12 cm. For example, it may be 9.1 cm, 9.2 cm, 9.3 cm, 9.4 cm, or the like.

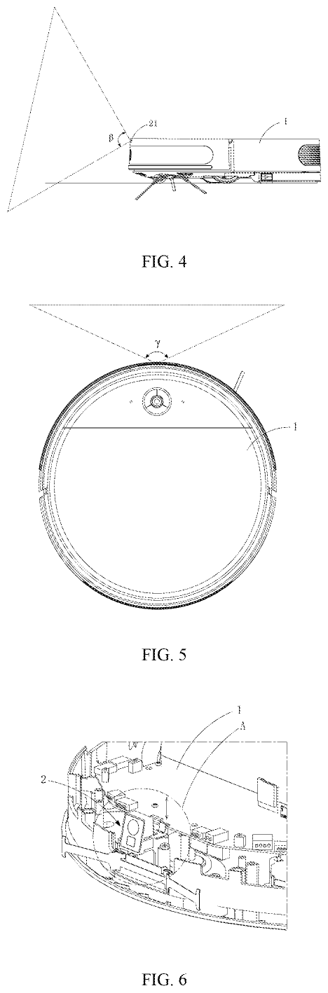

Referring to FIG. 4, which shows a side view of the mobile robot of the present application in an embodiment, a vertical field angle β of the image acquisition assembly 21 is 80° to 100°. In different embodiments, the vertical field angle β may be 80°, 85°, 90°, 95°, 100°, or the like. Of course, the above-mentioned vertical field angle β may be any integer angle in the above-mentioned range between 80° and 100°; for example, it may be 81°, 82°, 83°, 84°, 86°, 87°, 88°, 89°, 91°, 92°, 93°, 94°, 96°, 97°, 98°, or 99°; or it may be any non-integer angle in the above-mentioned range between 80° and 100°; for example, it may be 91.1°, 91.2°, 91.3°, 91.4°, 91.5°, 91.6°, 91.7°, 91.8°, or 91.9°.

Referring to FIG. 5, which shows a top view of the mobile robot of the present application in an embodiment, a horizontal field angle γ of the camera is 110° to 130° such that, with this wide horizontal field angle, the camera 21 can capture image information as wide as possible to meet the requirements of different functional modes. In different embodiments, the horizontal field angle γ may be 110°, 115°, 120°, 125°, 130°, or the like. Of course, the above-mentioned horizontal field angle γ may be any integer angle in the above-mentioned range between 110° and 130°; for example, it may be 111°, 112°, 113°, 114°, 116°, 117°, 118°, 119°, 121°, 122°, 123°, 124°, 126°, 127°, 128°, or 129°; or it may be any non-integer angle in the above-mentioned range between 110° and 130°; for example, it may be 121.1°, 121.2°, 121.3°, 121.4°, 121.5°, 121.6°, 121.7°, 121.8°, or 121.9°.

In this way, with this large vertical field angle, the camera 21 not only can capture image information of the ceiling, but also can capture image information of the ground to meet the requirements of different functional modes. For example, in some embodiments, the camera can capture image information of the ceiling, and images provided by the camera provides input information for the VSLAM mode to achieve localization and navigation of the mobile robot. In some embodiments, the camera can capture image information of the ground, and images provided by the camera provides input information for the obstacle avoidance mode to achieve autonomous obstacle avoidance of the mobile robot. In some embodiments, the camera can capture image information directly in front of the movement forward direction and the ground, and images provided by the camera provides input information for the docking mode to achieve autonomous docking of the mobile robot. In this case, compared with the prior art that needs to arrange various sensors on the mobile robot, such as an obstacle detector (e.g., an infrared range sensor, or a ToF sensor) on a buffer assembly, the present application allows the camera to have a wider photographic viewing angle due to the camera device provided at the front end of the housing, which can omits various types of obstacle detection and obstacle avoidance sensors at the front end of the mobile robot, thereby reducing the design difficulty and greatly lowering the overall cost of the mobile robot.

In some embodiments, the image acquisition assembly also includes an angle adjustment mechanism for adjusting a tilt angle of the camera. Using the angle adjustment mechanism, one or more of the included angle α between the optical axis of the camera 21 and the forward movement direction of the mobile robot, the vertical field angle β of the camera 21, and the horizontal field angle γ of the camera can be adjusted.

In the embodiment shown in FIGS. 2 to 5, the image acquisition assembly is illustrated schematically only.

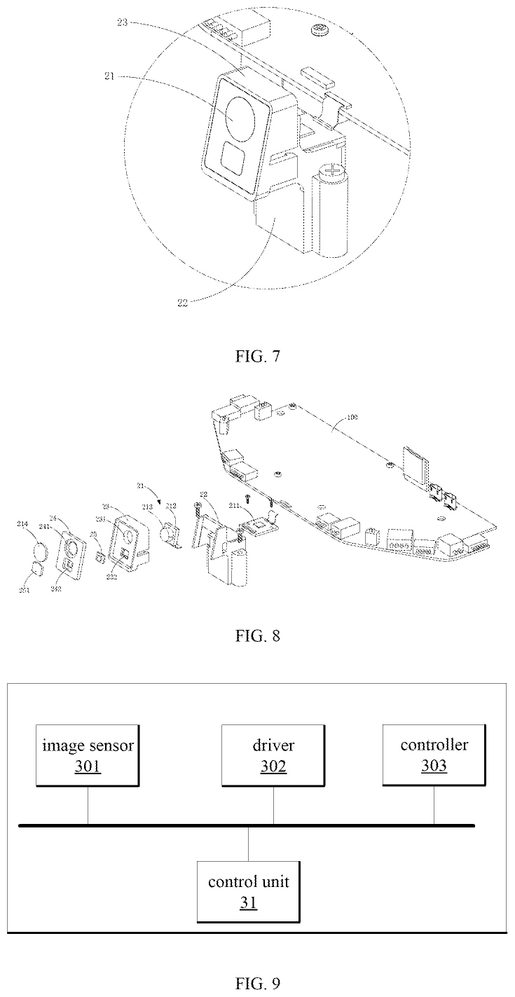

Please refer to FIGS. 6 and 7, wherein FIG. 6 shows a structure diagram of the image acquisition assembly of the mobile robot of the present application in an embodiment, and FIG. 7 shows an enlarged diagram at A in FIG. 6. As the image acquisition assembly is arranged at the intersection of the top surface and the side surface of the mobile robot, FIG. 7 only shows a partial structure of the front side of the mobile robot. In addition, to better show the overall structure of the image acquisition assembly, the image acquisition assembly in FIG. 7 is shown without a top cover on the top surface and a buffer assembly located at the front end of the mobile robot, etc.

As shown in FIGS. 6 and 7, the image acquisition assembly 2 in the mobile robot of the present application includes a mounting seat 22 and a camera module, wherein the camera module includes a camera base 23 and a camera 21.

The mounting seat 22 is configured to mount and fix the camera module to the robot body 1 (e.g., the housing of the robot body 1) of the mobile robot, i.e., the camera module is mounted and fixed to the mounting seat 22 and the mounting seat 22 is mounted and fixed to the housing of the robot body 1.

The mounting seat 22 has some structural strength and provides sufficient mounting space.

In the embodiment shown in FIG. 6, the mounting seat 22 can be removed in a vertical direction (see an arrow in FIG. 6) from the housing of the robot body 1, and later, the mounting seat can be fixed to the housing by locking attachment structures or clamping buckle structures.

In some embodiments, the locking attachment structures may include screw holes or bolts and screws. For example, as shown in FIG. 6, the bolts are provided on two opposite sides (e.g., left and right sides) of the mounting seat 22, wherein the bolts are arranged vertically, and correspondingly, the screw holes corresponding to the bolts are correspondingly provided at the bottom of the housing. When the mounting seat 22 needs to be mounted, the mounting seat 22 is inserted downwards in the vertical direction into the housing of the robot body 1 so that the bolts on the mounting seat 22 are aligned with the screw holes in the housing, and subsequently, the screws are pushed from the tops of the bolts of the mounting seat 22 until passing through the bolts and entering the screw holes in the housing, thus mounting and fixing the mounting seat 22 to the housing. When the mounting seat 22 needs to be removed, the screws are removed so that the mounting seat 22 is disengaged from the housing, and the mounting seat 22 is pulled upwards in the vertical direction, thus removing the mounting seat 22.

In some embodiments, the clamping buckle structures may include catching grooves or catching holes and clamping buckles or clamping hooks. The clamping buckles or clamping hooks are provided on two opposite sides (e.g., left and right sides) of the mounting seat, wherein the clamping buckles or clamping hooks are arranged vertically, and correspondingly, the catching grooves or catching holes corresponding to the clamping buckles or clamping hooks are provided at the bottom of the housing. When the mounting seat needs to be mounted, the mounting seat is inserted downwards in the vertical direction into the housing of the robot body so that the clamping buckles or clamping hooks on the mounting seat are embedded into the catching grooves or catching holes in the housing, thus mounting and fixing the mounting seat to the housing. When the mounting seat needs to be removed, the clamping buckles or clamping hooks on the mounting seat are operated so that the clamping buckles or clamping hooks on the mounting seat are disengaged from the catching grooves or catching holes in the housing, and the mounting seat is pulled upwards in the vertical direction, thus removing the mounting seat.

In other embodiments, the mounting seat can be removed in a horizontal direction from the housing of the robot body, and later, the mounting seat can be fixed to the housing by locking attachment structures or clamping buckle structures.

In some embodiments, the locking attachment structures may include screw holes or bolts and screws. For example, the bolts are provided on two opposite sides (e.g., left and right sides) of the mounting seat, wherein the bolts are arranged horizontally, and correspondingly, the screw holes corresponding to the bolts are correspondingly provided inside the housing. When the mounting seat needs to be mounted, the mounting seat is inserted inwards in the horizontal direction into the housing of the robot body so that the bolts on the mounting seat are aligned with the screw holes in the housing, and subsequently, the screws are pushed from the outside of the bolts of the mounting seat until passing through the bolts and entering the screw holes in the housing, thus mounting and fixing the mounting seat to the housing. When the mounting seat needs to be removed, the screws are removed so that the mounting seat is disengaged from the housing, and the mounting seat is pulled outwards in the horizontal direction from the housing.

In some embodiments, the clamping buckle structures may include catching grooves or catching holes and clamping buckles or clamping hooks. The clamping buckles or clamping hooks are provided on two opposite sides (e.g., left and right sides) of the mounting seat, wherein the clamping buckles or clamping hooks are arranged horizontally, and correspondingly, the catching grooves or catching holes corresponding to the clamping buckles or clamping hooks are provided inside the housing. When the mounting seat needs to be mounted, the mounting seat is inserted inwards in the horizontal direction into the housing of the robot body so that the clamping buckles or clamping hooks on the mounting seat are embedded into the catching grooves or catching holes in the housing, thus mounting and fixing the mounting seat to the housing. When the mounting seat needs to be removed, the clamping buckles or clamping hooks on the mounting seat are operated so that the clamping buckles or clamping hooks on the mounting seat are disengaged from the catching grooves or catching holes in the housing, and the mounting seat is pulled outwards in the horizontal direction from the housing.

The camera module is mounted and fixed to the mounting seat 22.

In the embodiment shown in FIG. 7, the camera module at least includes a camera base 23 and a camera 21, the camera 21 being arranged on the camera base 23, and the camera base 23 being mounted and fixed to the mounting seat 22.

In the embodiment shown in FIG. 7, the camera base 23 can be removed in the horizontal direction from the mounting seat 22, and later, the camera base 23 can be fixed to the mounting seat 22 by locking attachment structures or clamping buckle structures.

In some embodiments, the clamping buckle structures may include catching grooves or catching holes and clamping buckles or clamping hooks. For example, as shown in FIG. 7, the clamping buckles or clamping hooks are provided on two opposite sides (e.g., left and right sides) of the camera base 23, wherein the clamping buckles or clamping hooks are arranged horizontally, and correspondingly, the catching grooves or catching holes corresponding to the clamping buckles or clamping hooks are correspondingly provided on two opposite sides (e.g., left and right sides) of the mounting seat 22. When the camera base 23 needs to be mounted, the camera base 23 is inserted in the horizontal direction into the mounting seat 22 so that the clamping buckles or clamping hooks on the camera base 23 are embedded into the catching grooves or catching holes in the mounting seat 22, thus mounting and fixing the camera base 23 to the mounting seat 22. When the camera base 23 needs to be removed, the clamping buckles or clamping hooks on the camera base 23 are operated so that the clamping buckles or clamping hooks on the camera base 23 are disengaged from the catching grooves or catching holes in the mounting seat 22, and the camera base 23 is pulled in the horizontal direction from the mounting seat 22.

In some embodiments, the locking attachment structures may include screw holes or bolts and screws. For example, the bolts are provided on two opposite sides (e.g., left and right sides) of the camera base, wherein the bolts are arranged horizontally, and correspondingly, the screw holes corresponding to the bolts are correspondingly provided on two opposite sides (e.g., left and right sides) of the mounting seat. When the camera base needs to be mounted, the camera base is inserted in the horizontal direction into the mounting seat so that the bolts or mounting holes on the camera base are aligned with the screw holes in the mounting seat, and subsequently, the screws are pushed from the bolts or mounting holes of the camera base until passing through the bolts or mounting holes and entering the screw holes in the mounting seat, thus mounting and fixing the camera base to the mounting seat. When the camera base needs to be removed, the screws are removed so that the camera base is disengaged from the mounting seat, and the camera base is pulled in the horizontal direction from the mounting seat.

Please refer to FIG. 8, which shows an exploded diagram of the camera module in FIG. 6 in an embodiment. The camera module includes a camera base 23 and a camera 21, wherein the camera 21 includes a camera circuit board 211, an image sensor 212, and a lens assembly 213.

The lens assembly 213 is a set of lenses for collecting visible light within the previously mentioned field of view and imaging on the image sensor 212.

The image sensor 212 is electrically connected to the camera circuit board 211, and the lens assembly 213 is arranged directly in front of the image sensor 212.

The camera circuit board 211 is mounted and fixed to the mounting seat 22. For example, the camera circuit board 211 can be fixed to the mounting seat 22 by locking attachment structures or clamping buckle structures.

In some embodiments, the locking attachment structures may include screw holes and screws. For example, as shown in FIG. 8, the camera circuit board 211 can be fixed to the mounting seat 22 by one or more screws.

In some embodiments, the clamping buckle structures may include clamping buckles or clamping hooks. For example, the clamping buckles or clamping hooks are provided on the mounting seat, and the clamping buckles or clamping hooks on the mounting seat catch or hook the camera circuit board after the camera circuit board is placed in a corresponding mounting area of the mounting seat. Of course, the camera circuit board may also be provided with catching grooves or catching holes corresponding to the clamping buckles or clamping hooks.

The image sensor 212 and the lens assembly 213 are combined and arranged on the camera base 23, and the camera base 23 is provided with a corresponding camera mounting structure 231. The image sensor may be a charge-coupled device image sensor (CCD) or a complementary metal oxide semiconductor image sensor (CMOS), or the like.

Generally, the current image acquisition assembly usually use a charge-coupled device image sensor (CCD) or a complementary metal oxide semiconductor image sensor (CMOS) for image sensing. The image sensor converts light conducted from the lens assembly 213 into an electrical signal, which is then converted into a digital signal through an internal DA, and the digital signal is subjected to a series of amplification and storage, and then transmitted to a screen to form an image. The light conducted from the lens assembly 213 includes some infrared light in addition to visible light. The infrared light, though invisible to the human eye, can be sensed by the above-mentioned image sensor. After a series of conversion, the infrared light forms a false image on the finally formed image, leading to a problem that the image seen by the human eye and the image sensed by the image sensor are inconsistent, that is, a color cast problem occurs, which affect the photographic performance of the image acquisition assembly.

Thus, in some embodiments, the camera may also include an infrared cut filter. That is, an infrared cut filter is provided between the image sensor 212 and the lens assembly 213. The infrared cut filter may cut off infrared light and is highly transmissive for visible light, which can improve the aforementioned color cast problem and does not affect visible light imaging.

One side of the camera circuit board 211 may be electrically connected to the image sensor 212 by, for example, a flexible circuit board, and the other side of the camera circuit board 211 may be electrically connected to a main circuit board 100 in the housing of the robot body by, for example, a flexible circuit board.

In a practical implementation, the image acquisition assembly 2 may also be equipped with other components. For example, to avoid that images captured by the camera are unclear due to too dark ambient light, such that the requirement of a corresponding functional mode (e.g., obstacle detection and obstacle avoidance ODOA) cannot be met, in some embodiments, the image acquisition assembly may also include a light compensating lamp, which can be used for light compensating in a low light environment (e.g., in overcast and rainy weather, at dusk and night, or when the mobile robot travels under a sofa, a bed, a tea table or the like).

The light compensating lamp may be arranged at the periphery of the camera 21. One or more light compensating lamps may be provided. Using a single light compensating lamp as an example, in some embodiments, the camera and the light compensating lamp are arranged in a left-right direction of the camera base. For example, the camera is arranged on the left and the light compensating lamp is arranged on the right, or the camera is arranged on the right and the light compensating lamp is arranged on the left, wherein an optical axis of the lens assembly in the camera and an axis of the light compensating lamp are on the same horizontal line or there is an up-down distance therebetween in the vertical direction. In some embodiments, the camera and the light compensating lamp are arranged in an up-down direction of the camera base. For example, the camera is arranged above the light compensating lamp, or the camera is arranged below the light compensating lamp, wherein the optical axis of the lens assembly in the camera and the axis of the light compensating lamp are on the same vertical line or there is a horizontal distance therebetween in the horizontal direction. Using two light compensating lamps as an example, in some embodiments, the two light compensating lamps may include a left light compensating lamp and a right light compensating lamp, which are located on left and right sides of the single camera, respectively. In some embodiments, the two light compensating lamps may include an upper light compensating lamp and a lower light compensating lamp, which are located at upper and lower ends of the single camera, respectively.

In the embodiment shown in FIG. 8, the image acquisition assembly 2 also includes a light compensating lamp 25. The light compensating lamp 25 is located below the camera 21. Thus, the camera base 23 is provided with a corresponding light compensating lamp mounting structure 232, and the light compensating lamp mounting structure 232 is located below the camera mounting structure 231.

In practical applications, the light compensating lamp may be, for example, an LED light compensating lamp, such as a blue LED, a red LED, a green LED, or a white LED. For example, the blue LED has a shorter wavelength and stronger penetrability compared with the red LED or green LED, such that light reflected back is not liable to be scattered, and the image display effect is better. Of course, light compensating is not limited to the above-mentioned LED light compensating lamp, and in some embodiments, the light compensating lamp may also be an infrared light compensating lamp or a laser beam, etc.

In some embodiments, a protective cover plate 24 is also provided on the camera base 23, and a camera glass barrier 214 corresponding to the lens assembly 213 and a light compensating lamp glass barrier 251 corresponding to the light compensating lamp 25 are provided on the protective cover plate 24. For example, the protective cover plate 24 is provided with a first barrier mounting structure 241, and the camera glass barrier 214 is mounted on the first barrier mounting structure 241 of the protective cover plate 24; the protective cover plate 24 is provided with a second barrier mounting structure 242, and the filler glass barrier 251 is mounted on the second barrier mounting structure 242 of the protective cover plate 24; and later, the protective cover plate 24 is mounted and fixed to the camera base 23. The protective cover plate 24 can be mounted and fixed to the camera base 23 by, for example, double-sided adhesive or glue.

Using the structure of the image acquisition assembly disclosed above, the image acquisition assembly can be mounted and fixed to the housing of the robot body 1.

In some embodiments, please refer to FIG. 9, which shows a structure block diagram of the image acquisition assembly. A circuit structure arranged on the camera circuit board includes a control unit 31 (camera control). The control unit 31 is at least electrically connected to a circuit device in the camera, such as being electrically connected to at least one the following circuit devices: an image sensor 301, or a driver 302 of the lens assembly, or a controller 303 of an aperture, to enable the camera to output a first image frame sequence by controlling the corresponding circuit device.

The control unit is a processor for processing image data, such as a DSP (digital signal processor), which performs at least one of the following control operations related to capturing images on the image sensor, the lens assembly or the like: frame rate control, resolution control, focus control, and automatic exposure control.

The frame rate control is used to control time intervals at which the image sensor outputs images. For example, the control unit controls the image sensor to output the first image frame sequence at a frame rate of 25 fps.

The resolution control is used perform color conversion on a data matrix provided by the image sensor based on the number of pixels to output the first image frame sequence with consistent or inconsistent sharpness such as standard definition images, or high-definition images.

The focus control is used to control the driver of the lens assembly to perform focal length adjustment to obtain clear images reflecting a distant or close scene.

The automatic exposure control is used to adjust a duration of light admission of the aperture by controlling the controller of the aperture, to adjust the amount of admitted light focused on the image sensor.

In some specific examples, the control unit controls the aperture alone to adjust the amount of admitted light. For example, the control unit determines an aperture opening duration for capture of a frame of image by detecting light intensity data per unit time provided by the image sensor. In some other specific examples, the control unit controls the aperture and the light compensating lamp in the camera module to adjust the amount of admitted light. For example, the control unit controls flashing timing and duration of the light compensating lamp and controls an aperture opening duration, by detecting light intensity data per unit time provided by the image sensor, thereby obtaining a frame of image captured under supplement light.

The camera output an image frame sequence. The image frame sequence includes a plurality of frames of images captured based on a time series and represented by a color data array. The color data array is, for example, matrix data described using R, G, or B color data, or matrix data described using RGB color data, or matrix data described using YUV.

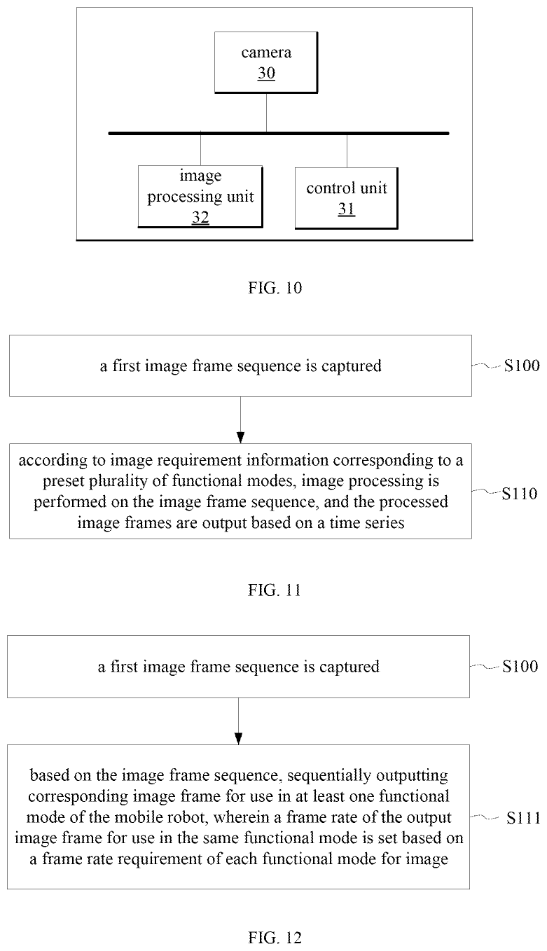

In some other embodiments, please refer to FIG. 10, which shows another structure block diagram of the image acquisition assembly. The image acquisition assembly also includes an image processing unit 32, such as an ISP (Image Signal Processor), or an image processing chip. The image processing unit 32 is connected to the camera 30, and performs image processing on a captured image frame sequence and outputs a processed image frame sequence. The image processing unit 32 is configured to provide, to subsequent hardware, image data easy to identify as a valid input for each functional mode. For example, the image processing unit 32 performs image correction and the like on the images in the first image frame sequence.

The image processing unit may also be electrically connected to the control unit, and acquires images matched with the functional modes of the mobile robot by instruction interaction with the control unit, and outputs an image frame sequence composed of the matched images.

The image processing unit and the control unit mentioned in the above examples are hardware in the visual control device. The visual control device also includes a circuit structure configured to support data transmission and operation between the image processing unit and the control unit, etc. Main hardware circuitry in the visual control device may be packaged together with the camera, or the main hardware circuitry in the visual control device may be packaged separately, or some hardware of the main hardware circuitry in the visual control device may be packaged together with the camera, and other hardware of the main hardware circuitry may be packaged separately.

In some embodiments, as shown in FIG. 8, a protective cover plate 24 is also provided on the camera base 23, and a camera glass barrier 214 corresponding to the lens assembly 213 is provided on the protective cover plate 24. For example, the protective cover plate 24 is provided with a first barrier mounting structure 241, and the camera glass barrier 214 is mounted on the first barrier mounting structure 241 of the protective cover plate 24, and later, the protective cover plate 24 is mounted and fixed to the camera base 23. The protective cover plate 24 can be mounted and fixed to the camera base 23 by, for example, double-sided adhesive or glue.

The mobile robot disclosed in the present application also includes a waterproof assembly, which is arranged between the image acquisition assembly and the housing. In some embodiments, the waterproof assembly may include a first baffle plate and a second baffle plate, wherein the first baffle plate is arranged on the top of a camera mounting seat, and the second baffle plate is arranged on a front end edge of the housing. When the image acquisition assembly is mounted and fixed to the housing, the first baffle plate and the second baffle plate overlap each other to achieve a waterproof effect. A waterproof strip, a waterproof leather ring, or the like may be additionally provided between the first baffle plate and the second baffle plate, or the first baffle plate and the second baffle plate may also be provided with engagement structures, which include, but are not limited to, cooperation of a first clamping buckle and a second clamping buckle, cooperation of the first clamping hook and a second clamping hook, cooperation of a clamping buckle or clamping hook and a catching groove or a catching hole. In some embodiments, the waterproof assembly may include a waterproof strip, a waterproof leather ring, or the like, which is placed between the camera mounting seat of the image acquisition assembly and the adjacent housing when the image acquisition assembly is mounted and fixed to the housing of the robot body.

The mobile robot disclosed in the present application has the following beneficial effects: the mobile robot of the present application is equipped with an image acquisition assembly, which is arranged on a side surface of a robot housing, or at the intersection of a top surface and the side surface of the robot housing, the image acquisition assembly including a camera, an optical axis of which is arranged in a tilted upward direction; in this way, the camera can have a wider photographic viewing angle and obtain image data with more information, which means that a single camera can be used to achieve multiple functions, such as localization and mapping, visual scene understanding, obstacle detection and obstacle avoidance, visual odometry, and visual docking, based on image acquisition; and compared with the related art, this can eliminate the need to deploy multiple sensors or multiple types of sensors, reduces the design difficulty and greatly lowers the overall cost of the mobile robot.

As described in the above example, the image acquisition assembly captures multiple frames of original images in succession to form an image frame sequence. For example, the image acquisition assembly captures multiple frames of original images at a frame rate of 25 frames per second (25 fps).

To facilitate the distinction between the original images captured by the image acquisition assembly and the sequence composed of the images, and between image frames output by the image acquisition assembly and a sequence thereof, now the sequence composed of the original image captured by the image acquisition assembly is called a first image frame sequence, and the sequence composed of the image frames output by the image acquisition assembly is called a second image frame sequence. The plurality of frames of images (also called image frames, or image data) in the first image frame sequence or the second image frame sequence are arranged according to the order of photographing time.

By means of the image acquisition assembly mentioned in the above examples, input information required for multiple functional modes can be provided within its field range, and thus, in some examples, a frame rate of the second image frame sequence output by the image acquisition assembly may be the same as that of the first image frame sequence. In other words, the image acquisition assembly outputs each captured image to subsequent hardware of the mobile robot, such as to a control system of the mobile robot. Hence, the control system in the mobile robot extracts data related to the functional modes from the second image frame sequencer received, and by running the functional modes, selects one of the functional modes to perform a corresponding behavior. In some further examples, the second image frame sequence is obtained by image processing of the first image frame sequence by the image acquisition assembly according to the image requirement of each functional mode run by the control system. Hence, when receiving the second image frame sequence, the control system in the mobile robot provides each image frame therein to a functional mode adapted thereto, and by running the corresponding functional mode, selects one of the functional modes to perform a corresponding behavior.

For example, one the one hand, the control system performs a movement operation in the navigation mode/mapping mode by using a first image frame in the received second image frame sequence; and on the one hand, it identifies a second image frame in the received second image frame sequence to reflect data of surrounding obstacles, and accordingly chooses to continue the movement operation in the navigation mode/mapping mode or to perform an obstacle avoidance operation in the obstacle avoidance mode.

The control system in the above examples will be exemplified subsequently. The image acquisition assembly is connected to the control system in the mobile robot by a data line, such as a USB, RS232, AHB bus, APB bus or other serial interface, and/or an HDMI, BUS or other parallel interface. For example, the image processing unit in the image acquisition assembly is connected to the control system by two USB interfaces, wherein one USB interface is used to output the second image frame sequence, and the other USB interface is used for instruction interaction with the control system. As another example, the image processing unit in the image acquisition assembly is connected to the control system by a USB interface and bus interfaces, wherein the USB interface is used to output the second image frame sequence, and AHB and APB bus interfaces are used in combination for instruction interaction with the control system.

To reduce resource occupation of data processing by the control system and to improve utilization efficiency of the images in the first image frame sequence captured by the image acquisition assembly, the present application provides an image processing method.

Please refer to FIG. 11, which shows a flow diagram of an image processing method of the image acquisition assembly. The image processing method is mainly executed by the previously mentioned visual control device. For example, the image processing unit in the visual control device is the main executing device, which works in cooperation with the control unit, the camera and other hardware under instructions of the image processing unit, and each frame of image in the output second image frame sequence is adapted to the image requirement of at least one functional mode that is currently run by the control system. For convenience of description, the image processing method is described with a working process of the image acquisition assembly.

In step S100, a first image frame sequence is captured. As described above, the image acquisition assembly captures the first image frame sequence.

In step S110, according to image requirement information corresponding to a preset plurality of functional modes, image processing is performed on the image frame sequence, and the processed image frames are output based on a time series. The output image frames are for use in at least one functional mode of the mobile robot. In other words, a second image frame sequence is output based on the first image frame sequence, wherein each image frame in the second image frame sequence is correspondingly for use in at least one functional mode of the mobile robot, respectively, and each image frame in the second image frame sequence corresponds to the image requirement information of at least one functional mode.

The purpose of the image processing of the first image frame sequence by the image acquisition assembly is providing to the control system multiple frames of images with overlapping field ranges captured at different locations, during continuous movement of the mobile robot, to reflect the movement of the mobile robot and the surrounding environment by using image data differences between the different images captured at different locations. The image requirement information is a quantitative requirement on images intended to acquire valid input information from the images for at least one functional mode. The image requirement information may be stored in the image acquisition assembly by using charts, profiles, or the lie, or recorded as parameters in a program. The image requirement information reflects, for example, at least one of the following quantitative requirements on images for at least one functional mode: a frame rate interval, an image brightness interval, and an image area.

In some embodiments, the image requirement information includes a frame rate interval of images corresponding to each functional mode. The frame rate intervals corresponding to different functional modes may be the same or different, to achieve the purpose that each functional mode obtains, from images of the corresponding frame rate, input data matched with its autonomous behavior. In all functional modes of the mobile robot, at least two of the frame rate intervals are different. The different frame rate intervals include: frame rate intervals that do not overlap, or intervals that only partially overlap. Using an example of the aforementioned mobile robot having at least one of the functional modes of visual localization and mapping, obstacle avoidance, visual docking, visual scene understanding, and visual tracking, an image frame rate (or frame rate interval) corresponding to the visual localization and mapping or visual scene understanding is not less than 2 frames per second; an image frame rate (or frame rate interval) corresponding to the obstacle avoidance or visual tracking is not less than 7 frames per second; and an image frame rate corresponding to the visual docking is not less than 20 fps.

Hence, please refer to FIG. 12, which shows a flow diagram of the image acquisition assembly in an embodiment. Step S110 includes step S111: based on the image frame sequence, sequentially outputting corresponding image frame for use in at least one functional mode of the mobile robot, wherein a frame rate of the output image frame for use in the same functional mode is set based on a frame rate requirement of each functional mode for image.

As described above, the frame rate requirements are expressed as the frame rate intervals in the image requirement information. Based on the different frame rate intervals set in the image requirement information, the image acquisition assembly processes the first image frame sequence in terms of frame rate according to the frame rate of at least one functional mode predetermined with the control system, and outputs a second image frame sequence that meets the determined frame rate requirements of all the functional modes. The frame rates of the first image frame sequence and the second image frame sequence are not necessarily correlated. Time intervals between adjacent frames of images in the second image frame sequence may be uniform or non-uniform.

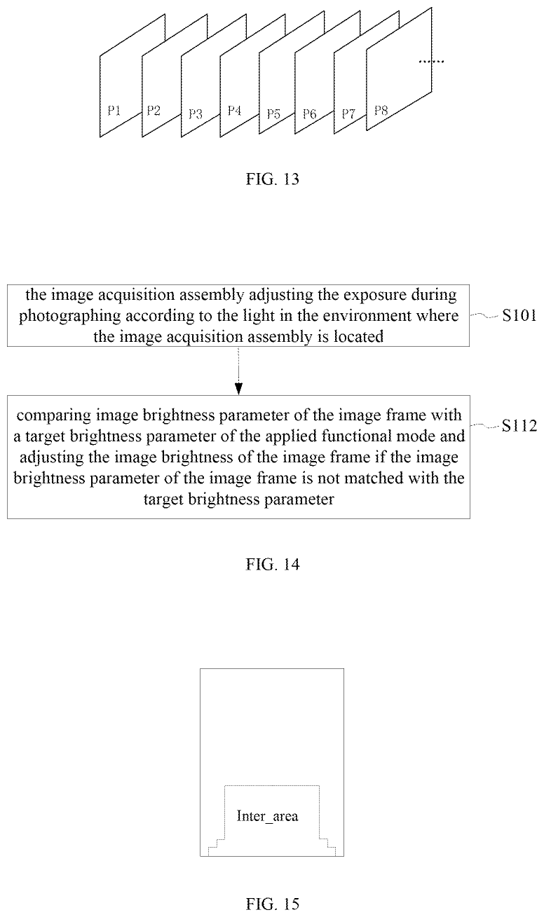

For example, the output second image frame sequence includes multiple frames of images with different frame rate intervals therebetween. Referring to FIG. 13, which shows a schematic diagram of a second image frame sequence, the image acquisition assembly processes the first image frame sequence in terms of frame rate based on two different frame rate intervals corresponding to the obstacle avoidance mode and the VSLAM mode in the image requirement information; images P1, P4, P8 . . . in the second image frame sequence obtained are arranged based on the frame rate interval of the VSLAM mode; and images P2, P3, P5, P6, P7 . . . in the second image frame sequence are arranged based on the frame rate interval of the obstacle avoidance mode. In the case the frame rate interval of the obstacle avoidance mode is satisfied, the time interval between the images P2 and P3 is different from the time interval between the images P3 and P5 in the obstacle avoidance mode. Alternatively, in the case the frame rate intervals of the VLSAM mode and the obstacle avoidance mode are both satisfied, the image acquisition assembly adjusts the time intervals between adjacent frames of images in such a manner that the time interval between the images P1 and P2 is the same as the time interval between the images P3 and P5 in the obstacle avoidance mode; and the time interval between the images P1 and P4 is different from the time interval between the images P4 and P8 in the VSLAM mode.

As another example, the output second image frame sequence includes at least one frame of image that satisfies the frame rate requirements of the same or different frame rate intervals; in other words, the frame of image provides information input for a plurality of functional modes that satisfy the corresponding frame rate intervals.

Still using FIG. 13 as an example, the image acquisition assembly processes the first image frame sequence in terms of frame rate based on the same frame rate interval corresponding to the obstacle avoidance mode and the VO mode in the image requirement information; images P1, P2, P2 . . . in the second image frame sequence obtained are all arranged based on the frame rate interval of the obstacle avoidance mode and the VO mode. In other words, the images P1, P2, P3, . . . all provide information inputs to the obstacle avoidance mode and the VO mode run by the control system.

Still referring to FIG. 13, the image acquisition assembly processes the first image frame sequence in terms of frame rate based on different frame rate intervals corresponding to the obstacle avoidance mode and the VSLAM mode in the image requirement information; images P1, P3, P5, P7 . . . in the second image frame sequence obtained are arranged based on the frame rate interval of the VSLAM mode; and images P2, P3, P4, P6, P7, P8 . . . in the second image frame sequence are arranged based on the frame rate interval of the obstacle avoidance mode. The images P3 and P7 are images that meet the frame rate requirements of both the obstacle avoidance mode and the VSLAM mode.

In some applications, in the case where frame rate requirement combinations are substantially stable in all functional modes of the mobile robot, the image acquisition assembly performs frame rate processing on the first image frame sequence according to preset frame rate requirement information corresponding to the frame rate requirement combinations, and images in the second image frame sequence obtained are used to provide information inputs to corresponding multiple functional modes run by the control system.

Using an example in which the functional modes of the mobile robot include a navigation mode, a VSLAM mode, an obstacle avoidance mode, and a visual tracking mode, the frame rate requirements of the navigation mode and the VSLAM modes are substantially the same, and the frame rate requirements of the obstacle avoidance mode and the visual tracking mode are substantially the same, so the frame rate information pre-stored in the image acquisition assembly include two frame rate intervals, wherein a frame rate interval of the navigation mode and the VSLAM mode is not less than 2 frames per second (fps); and a frame rate interval of the obstacle avoidance mode and the visual tracking mode is not less than 7 fps. For example, the image acquisition assembly performs time series processing on the first image frame sequence based on the frame rate requirement information of frame rates of not less than 3 fps, and between 7-12 fps, and outputs the second image frame sequence.

To provide to the control system the second image frame sequence with overlapping field ranges that meets the frame rate interval requirements during the continuous movement of the mobile robot, the image acquisition assembly performs time series processing by, for example, adjusting the time intervals of the images in the first image frame sequence, and/or selecting images from the images in the first image frame sequence.

Using the aforementioned frame rate interval of not less than 3 fps as an example of the frame rate interval, the image acquisition assembly selects 3 frames of images with substantially the same time interval from the first image frame sequence with a unit duration as a period, and arranges the selected frames of images based on a photographing time series thereof in the first image frame sequence to obtain the second image frame sequence.

Using the aforementioned frame rate intervals including a frame rate interval of not less than 3 fps and a frame rate interval of 10 fps as an example, the image acquisition assembly selects 3 frames of images with substantially the same time interval from the first image frame sequence and selects 10 frames of images with substantially the same time interval different from the aforementioned 3 frames of images from the first image frame sequence with a unit duration as a period, and arranges and output the selected frames of images based on a photographing time series thereof in the first image frame sequence to obtain the second image frame sequence.

To reduce the probability that the control system performs multiple times of image processing on the same image for different functional modes, each frame of image in the second image frame sequence output by the image acquisition assembly corresponds to as few frame rate requirements as possible. For example, in the case at least two frame rate requirements are satisfied, the image acquisition assembly uses a minimally repetitive image extraction mechanism to process the first image frame sequence. The minimally repetitive image extraction mechanism means that the number of different frame rate requirements satisfied by the same image extracted is as small as possible, thereby facilitating image processing by the control system according to image processing methods of different functional modes, to reduce complex operations caused by multiple times of processing of the same frame of image by the control system. Still using the aforementioned frame rate intervals including a frame rate interval of not less than 3 fps and a frame rate interval of 10 fps as an example, the image acquisition assembly extracts 13 frames of images from the first image frame sequence of 25 frames in a unit duration of a second; and assigns the functional modes corresponding to the frames of images in a roughly equal division manner and outputs the frames of image to obtain the second image frame sequence.

In the above examples, time series processing is performed on the images in the first image frame sequence to obtain a second image frame sequence that meets the frame rate requirement in at least one functional mode, and the second image frame sequence can be allocated by the control system to the corresponding functional mode, and the functional modes are run to obtain information inputs about changes in the surrounding environment during the movement of the mobile robot from the corresponding images, such as obtaining information related to position changes such as localization features, obstacle information, and charging pile information from the images of the corresponding frame rate, so that the control system chooses to perform the movement behavior in one of the functional modes based on the obtained information.

In practical applications, light in a real physical space changes with the time of a day, or with indoor lighting. In the same physical space, the control system of the mobile robot may control the mobile robot to perform different behaviors based on different images captured under different ambient light. For example, in the case of strong ambient light, the control system in the VSLAM mode extracts first landmark feature data in the received multiple frames of images and thereby builds map data of the corresponding physical space; and in the same physical space, in the case of weak ambient light, the control system in the navigation mode extracts second landmark feature data in the received multiple frames of images, wherein the extracted second landmark feature data may be not sufficient to match with the first landmark feature data in the map data, so the control system cannot determine the current position of the mobile robot in the map data. As another example, in the case of strong ambient light, the control system in the obstacle avoidance mode identifies obstacle information in the received images and thereby performs a corresponding obstacle avoidance operation in time; and in the same physical space, in the case of weak ambient light, the control system in the obstacle avoidance mode may be not sufficient to identify obstacle information from the received images, and thus does not perform a corresponding obstacle avoidance operation in time, and the mobile robot collides with an obstacle. As yet another example, under the same ambient light, an image with strong exposure correspondingly can provide data that reflects an environment relatively far from the mobile robot; and an image with weak exposure correspondingly can provide data that reflects an environment relatively close to the mobile robot.

In order for the control system to obtain images as an input useful for a running functional mode so that the mobile robot performs a corresponding operation correctly, in other embodiments, the frames of images in the second image frame sequence output by the image acquisition assembly meet the image requirement on image brightness for the corresponding functional mode. For example, the image acquisition assembly performs image processing on the captured first image frame sequence to output a second image frame sequence that meets the image brightness requirement for the corresponding functional mode.

In the case of very low ambient light, the image brightness requirement for the corresponding functional mode still cannot be satisfied if the image acquisition assembly adjusts the image brightness by means of image processing only. In some applications, referring to FIG. 14, which shows a flow diagram of the image acquisition assembly in yet another embodiment, step S100 includes step S101: the image acquisition assembly adjusting the exposure during photographing according to the light in the environment where the image acquisition assembly is located, so that the frames of images in the captured first image frame sequence contain data corresponding to objects placed in the field range.

The control unit in the image acquisition assembly detects the light intensity of the environment in which the mobile robot is located by using a light-sensitive device such as an image sensor, and adjusts at least one of a shutter duration, an aperture size, and whether to enable a light compensating lamp during photographing based on the value of detected light intensity.

In some examples, under the control of the control unit, the image sensor outputs the first image frame sequence so that the image processing unit adjusts the brightness of the corresponding images according to a corresponding power mode.

In some further examples, the control unit in the image acquisition assembly adjusts the exposure according to a high or low exposure instruction of the image processing unit to output a first image frame sequence composed of images obtained based on at least one type of exposure control. Here, the image processing unit sends an instruction containing high exposure or low exposure to the control unit according to image requirement information of at least one functional mode to be output to the control system.

In some other examples, based on an image time series corresponding to each functional mode predetermined with the image processing unit and a corresponding exposure requirement, the control unit in the image acquisition assembly captures images that meet the corresponding exposure requirement, and outputs, based on the time series, a first image frame sequence composed of images obtained based on at least one type of exposure control.

Not limited to the above applications and examples, the image requirement information preset in the image acquisition assembly includes at least two different image brightness intervals (also known as target brightness parameters) corresponding to multiple functional modes. The image brightness interval is expressed as quantified data that adapts to the corresponding functional mode so that the overall or local brightness of the corresponding images meet the brightness requirement. The image brightness interval includes, for example, an interval range set based on at least one of the following: a brightness extreme value, brightness variance, brightness mean, and brightness distribution. The different image brightness intervals include image brightness intervals without overlapping intervals, or image brightness intervals containing partially overlapping intervals. For example, the image brightness intervals correspond to evaluations of overall brightness of the frames of images in the captured first image frame sequence. As another example, as image areas of interest to different functional modes are not necessarily the same, the image brightness intervals correspond to evaluations of local brightness of the image areas corresponding to the functional modes in the frames of images in the captured first image frame sequence.

Thus, the image acquisition assembly performs image brightness processing on some or all of the images in the first image frame sequence and outputs image frames based on a time series.

Still referring to FIG. 14, step S110 includes step S112: comparing image brightness parameter of the image frame with a target brightness parameter of the applied functional mode and adjusting the image brightness of the image frame if the image brightness parameter of the image frame is not matched with the target brightness parameter.

The image brightness parameters of the image frames are calculated by the image acquisition assembly according to brightness-related image processing conditions of the images for the functional modes. The brightness-related image processing conditions include, for example, determining an image area corresponding to a functional mode, or an image processing range of the image as a whole.

In some examples, the image acquisition assembly extracts a corresponding image area of an image in the first image frame sequence based on the area of interest corresponding to each functional mode and calculates an image brightness parameter within the image area; and by comparing the calculated image brightness parameter with an image brightness interval corresponding to the functional mode, determines whether the corresponding image is matched with the image brightness requirement for the corresponding functional mode.

The image acquisition assembly calculates at least one of, for example, a brightness extreme value, brightness variance, brightness mean, and brightness distribution for the brightness within the selected area of interest (e.g., the image area or the images as a whole) to obtain the image brightness parameter. The obtained image brightness parameters are compared with the image brightness interval corresponding to the functional mode to evaluate whether the brightness of the images in the obtained first image frame sequence meets the image brightness requirement for the corresponding functional mode; if so, the corresponding images are output one by one based on a time series, and if not, the image acquisition assembly adjusts the image brightness of the corresponding image areas so that the adjusted image areas fall into the corresponding image brightness interval.

For example, image requirement information corresponding to the obstacle avoidance mode includes an image area Bottom_Area at the lower part of an image and its image brightness interval Bright_Interval_1, and image requirement information corresponding to the navigation mode includes an image area Upper_Area of the upper part of the image and its image brightness interval Bright_Interval_2, wherein the image area Upper_Area and the image area Bottom_Area do not overlap or partially overlap. Based on the different image areas corresponding to the two functional modes, the image acquisition assembly calculates image brightness parameters respectively for the corresponding image areas of a frame of image P11 in the first image frame sequence, and compares the obtained two image brightness parameters with respective image brightness intervals respectively, and if both image brightness parameters fall into the respective image brightness intervals, the image acquisition assembly outputs the image so that the control system uses the image area Upper_Area of the image for navigation data processing and uses the image area Bottom_Area for obstacle avoidance data processing; conversely, if at least one of the image brightness parameters does not fall into the corresponding image brightness interval, the image acquisition assembly adjusts the image brightness of the corresponding image area so that the adjusted two image areas fall into the respective image brightness intervals.

As another example, based on frame rate and image brightness related information, such as a frame rate interval and an image brightness interval, in image requirement information corresponding to each functional mode, the image acquisition assembly sets a frame of image P12 in the first image frame sequence as an image for the obstacle avoidance mode, and performs image brightness calculation corresponding to the obstacle avoidance mode to obtain an image brightness parameter; if the image brightness parameter falls into an image brightness interval corresponding to the obstacle avoidance mode, the image acquisition assembly outputs the image so that the control system uses the image for obstacle avoidance data processing; conversely, if the image brightness parameter does not fall into the corresponding image brightness interval, the image acquisition assembly adjusts the image brightness of the corresponding image so that the image brightness parameter of the image after the brightness adjustment falls into the corresponding image brightness interval.

In some other examples, the image brightness parameter of the Bottom Area image frame is calculated based on an area of interest corresponding to each functional mode and a weight value thereof. The size of the area of interest, the position of the area of interest in the image, and the weight value of the area of interest are all related to data of a valid input of the captured image for the functional mode. The position and size of the area of interest in the image may be preset according to an image area corresponding to the functional mode.

For example, referring to FIG. 15, which shows a schematic diagram of an area of interest corresponding to the obstacle avoidance mode in the image, wherein the area of interest Inter_area corresponds to a position at the lower half of the image, and the range of the area of interest Inter_area is shown in FIG. 15, wherein the outline of the area of interest is in a stepped shape with the calculation precision of the obstacle avoidance mode and the reliability of the surrounding environment reflected in the image. The image acquisition assembly calculates an image brightness parameter of pixels in the stepped shape, and compares the parameter with an image brightness interval corresponding to the obstacle avoidance mode; if the image brightness parameter falls into an image brightness interval corresponding to the obstacle avoidance mode, the image acquisition assembly outputs the image so that the control system uses the image for obstacle avoidance data processing; conversely, if the image brightness parameter does not fall into the corresponding image brightness interval, the image acquisition assembly adjusts the image brightness of the corresponding image so that the image brightness parameter of the image after the brightness adjustment falls into the corresponding image brightness interval.

As another example, the area of interest is a preset unit image block, such as an image block of 4×4, 8×8, or 16×16, and an image in the first image frame sequence is divided into blocks with the area of interest as a unit; and the image brightness parameter of the image frame is calculated based on a weight value corresponding to the position of each area of interest in the image.

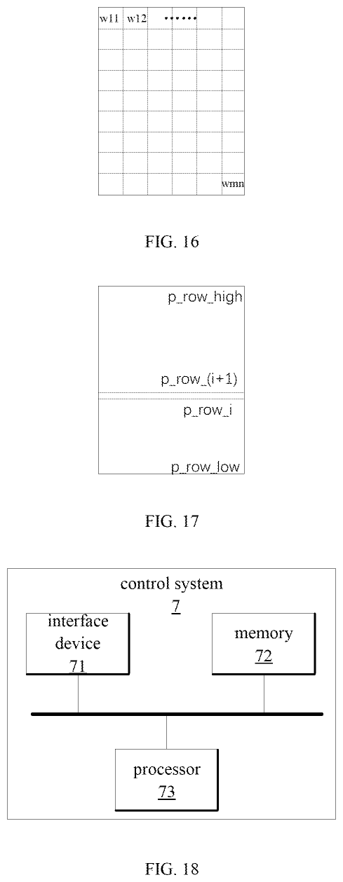

Referring to FIG. 16, which shows a schematic diagram of weight distribution of an area of interest of a functional mode corresponding to an image, the image acquisition assembly perform weighted calculation on pixel values of image block positions on an image selected from the first image frame sequence, based on a mapping relationship between the weight distribution (w11, w12 . . . wmn) of different functional modes and the positions of image blocks, to obtain an image after color adjustment; perform calculation of at least one of a brightness extreme value, brightness variance, brightness mean, and brightness distribution on the image after color adjustment, to obtain an image brightness parameter; and compares the image brightness parameter with an image brightness interval for a corresponding function mode; if the image brightness parameter falls into an image brightness interval corresponding to the obstacle avoidance mode, the image acquisition assembly outputs the image so that the control system uses the image for obstacle avoidance data processing; conversely, if the image brightness parameter does not fall into the corresponding image brightness interval, the image acquisition assembly adjusts the image brightness of the corresponding image so that the image brightness parameter of the image after the brightness adjustment falls into the corresponding image brightness interval.

As shown in the above example, the weight distribution varies with the information input requirement of the surrounding environment in different functional modes. For example, in the docking mode, a weight value in a middle area of the image is higher than a weight value in a surrounding area. As another example, in the functional mode of obstacle avoidance or visual tracking, a weight value in a ground image area in the image corresponding to the ground is higher than a weight value in an above-ground image area corresponding to above the ground. As yet another example, in the functional mode of visual localization and mapping (VSLAM mode), a weight value in the ground image area is lower than a weight value in the above-ground image area. In order not to discard information in image areas with low weights, the weight values may be set in a range of values greater than 0.

The ground image area and the above-ground image area are image areas in the image set by the image acquisition assembly. In some examples about a ground image area and an above-ground image area, the ground image area and the above-ground image area are determined based on image areas in the captured image where a ground range and an above-ground range in a field range of the image acquisition assembly are respectively located. For example, referring to FIG. 17, which shows a schematic diagram of a ground image area and an above-ground image area in an image, the image acquisition assembly determines an image area between the lowest pixel row p_row_low of the image and a pixel row p_row_i in a middle area of the image as the ground image area, and an image area between a pixel row p_row_(i+1) and the highest pixel row p_row_high of the image as the above-ground image area.

In some other examples about a ground image area and an above-ground image area, the ground image area and the above-ground image area are determined based on extracted ground image features in an image. The ground image features are derived from a lower edge image area of an image in the first image frame sequence. For example, the image acquisition assembly extracts image features in a lower edge image area of at least one frame of image in the first image frame sequence; by comparing the image features and finding similarities therebetween, selects some image features as image features representing the ground in the environment where the mobile robot is located; and according to the distribution of the selected image features in the image, determines, based on an area in a certain image where the image features are concentrated, a ground image area in the corresponding image, and determines the remaining image area as an above-ground area.

The image acquisition assembly performs weighted calculation on the images in the first image frame sequence according to preset weight distribution corresponding to each functional mode. For example, the image acquisition assembly reassigns values to pixels in the images by using the weight distribution.

The image acquisition assembly calculates image brightness parameters of the images after weight adjustment. For example, the image acquisition assembly calculates data such as an image histogram and a brightness average of the images after weight adjustment; uses data such as a brightness contrast determined based on the image histogram, and the brightness average as image brightness parameters, and compares the image brightness parameters with corresponding image brightness intervals; and based on a comparison result, repeatedly adjusts data such as the image histogram and the brightness average corresponding thereto until the image brightness parameters of the adjusted images meet the image brightness intervals. The image acquisition assembly outputs the adjusted images based on a time series to obtain a second image frame sequence.

Methods of adjusting an image brightness parameter that can be applied to any of the above examples include, for example, at least one of the following: adjusting an image gain of a corresponding image frame, adjusting a brightness contrast of a corresponding image frame, and increasing/decreasing a brightness extreme value interval of an image. For example, an image gain of a corresponding image frame is adjusted by increasing the brightness of the whole frame of image. As another example, adjust the brightness contrast by changing the brightness distribution of the histogram. As another example, a brightness contrast in an image is changed by increasing a brightness extreme interval.

Here, the image acquisition assembly sends the processed images corresponding to at least one functional mode to the control system based on a time series, as agreed with the control system. As described in the preceding example, the images in the output second image frame sequence may provide an information input to one functional mode, or may provide an information input to multiple functional modes. For example, different image areas in the images in the output second image frame sequence correspond to different functional modes. As another example, the images in the output second image frame sequence correspond only to a functional mode that is interested in the same image area.

In some applications, for an image area in an image that is of interest to a corresponding functional mode, or for an image area in an image that is insufficient to provide an accurate information input, the image acquisition assembly performs image segmentation before output.

The image segmentation includes, for example, setting the weight of the corresponding image area to 0 in the weight distribution in the image acquisition assembly, such that the images in the second image frame sequence become segmented images. Alternatively, the image segmentation includes, for example, segmenting an image in the first image frame sequence based on an image area in the corresponding image that conforms to a corresponding image brightness interval.

In the above examples, image brightness processing is performed on the images in the first image frame sequence to obtain a second image frame sequence that meets the image brightness requirement in at least one functional mode, and the second image frame sequence can be allocated by the control system to the corresponding functional mode, and the functional modes are run to extract valid information inputs of the surrounding environment of the mobile robot from the corresponding images, such as obtaining localization features, obstacle information, or charging pile information from the images, and the control system chooses to perform the movement behavior in one of the functional modes based on the confirmed information.

To enable the control system to perform subsequent processing according to the use of the images in the second image frame sequence, a transmission protocol or image sequencing rule is configured between the image acquisition assembly and the control system.

In some examples, the image acquisition assembly performs the image processing mentioned in any of the above examples, such as at least one of frame rate filtering, image brightness processing, and image segmentation, on the images in the received first image frame sequence, respectively, according to each quantified image requirement in the image requirement information. Thus, corresponding to the same functional mode, one frame of image in the first image frame sequence is processed into at least one frame of image in the second image frame sequence. The image acquisition assembly adds labels to corresponding images so that the images are identified by the control system. The labels include, but are not limited to, at least one type of the following: a label indicating at least one applicable functional mode, a label indicating at least one applicable frame rate requirement, a label indicating at least one applicable image brightness requirement, and a label indicating photographing time.

For example, the image acquisition assembly outputs the second image frame sequence at a frame rate of 25 frames per second, and the frames of images in the second image frame sequence not only satisfy an image requirement corresponding to a functional mode of 25 fps, but also some of the images satisfy image requirements for functional modes of not less than 3 fps, and not less than 10 fps. The labels in the output frames of images are used to identify frame rate requirements applicable to the corresponding images.

As another example, multiple frames of images in the output second image frame sequence are obtained after different image processing of the same image in the first image frame sequence by the image acquisition assembly. In this case, the labels in the output frames of images are used to identify the frame rate requirement and the image brightness requirement applicable to the corresponding images.

In some other examples, the image acquisition assembly is pre-preset with a synchronization mechanism with the control system and preset with an image output order corresponding to each functional mode, and thereby outputs the second image frame sequence. Specifically, in the case of synchronous transmission with the control system, the image acquisition assembly outputs the second image frame sequence according to the preset image output order. The synchronization mechanism is a mechanism that uses, for example, a synchronization control signal generated based on clock signals in the image acquisition assembly and/or the control system to transmit images. The image output order is, for example, a preset image output order set to meet image requirement information in all functional modes. In a specific example, time intervals between adjacent images in the second image frame sequence and a time series thereof are set to meet frame rate requirements for all functional modes. In yet another specific example, am image alternating mechanism is set to meet different frame rate requirements. For example, multiple frames of images at a frame rate of no less than 3 fps are arranged alternately between multiple frames of images at a frame rate of no less than 10 fps. In another specific example, a cyclic transmission mechanism is set to meet image brightness requirements for all functional modes. For example, the image requirement information includes three types of image brightness requirement information corresponding to different functional modes, and the image acquisition assembly processes the images in the first image frame sequence into three frames of images that meet the three image brightness requirements, and sequentially outputs the processed three frames based on the preset output order of the image brightness requirements.

Considering the frame rate requirements in multiple frames of images for different functional modes of the mobile robot and the resources for image processing by the control system in different functional modes, in some applications, the second image frame sequence output by the image acquisition assembly includes images corresponding to multiple functional modes, for subsequent processing by the control system.

In some other applications, the image acquisition assembly may also choose, under control of the control system, to output the second image frame sequence based on the image requirement information of at least one functional mode. The control system sends a control instruction to the image acquisition assembly, and the image acquisition assembly outputs the corresponding second image frame sequence according to instruction information in the control instruction. The control instruction contains instruction information reflecting a power mode. For example, the instruction information contains information of at least one of a frame rate requirement, an image brightness requirement, and an image area requirement corresponding to the functional mode, or identification information indicating a power mode (or frame rate interval), etc. The image acquisition assembly adjusts the output image frame sequence according to the control instruction.

Using instruction information containing a frame rate requirement as an example, the image acquisition assembly adjusts the time intervals between the frames of images in the second image frame sequence according to the received instruction information. For example, the image acquisition assembly captures a first image frame sequence at a frame rate of 25 fps, and when receiving a control instruction containing information indicating the VSLAM mode and the obstacle avoidance mode, the image acquisition assembly extracts, from the first image frame sequence, images that meet the frame rate requirement of not less than 3 fps and images that meet the frame rate requirement of not less than 10 fps, based on the frame rate requirements of not less than 3 fps and not less than 10 fps corresponding to the VSLAM mode and the obstacle avoidance mode respectively, and a minimally repetitive image extraction mechanism, to form a second image frame sequence with a frame rate of not less than 13 fps. When the image acquisition assembly receives instruction information containing information indicating the docking mode, the image acquisition assembly captures a first image frame sequence still at the frame rate of 25 fps, and the image acquisition assembly outputs frames of images in the first image frame sequence based on a time series to form a second image frame sequence. In this way, when the instruction information changes, the time intervals between adjacent image frames in the second image frame sequence change.

Using instruction information containing an image brightness requirement as an example, the image acquisition assembly adjusts the image brightness of the frames of images in the output second image frame sequence according to the received instruction information. If the instruction information contains the navigation mode and the obstacle avoidance mode, the image acquisition assembly outputs the second image frame sequence meeting corresponding image brightness requirements based on a preset mode output order; and if the instruction information contains the docking mode, the images in the second image frame sequence output by the image acquisition assembly meet a docking mode image brightness requirement.

To reduce the amount of data in the image acquisition assembly and control system, redundant information in the second image frame sequence, such as two frames of images containing overlapping image areas, is reduced.

In some other applications, the image acquisition assembly performs time series processing on the frames of images in the first image frame sequence based on frame rate requirements, and while performing the time series processing, also performs image processing such as image brightness processing, and/or image area selection on the corresponding images, so that the images in the output second image frame sequence not only meet frame rate requirements of different functional modes, but also meet image brightness requirements and/or image area requirements, etc. of the corresponding functional modes. In other words, the image acquisition assembly outputs image frames after brightness comparison processing and/or after image area extraction processing according to the frame rate requirements corresponding to the corresponding functional modes to form the second image frame sequence.

Using a second image frame sequence output by the image acquisition assembly containing images corresponding to the navigation mode and the obstacle avoidance mode as an example, image requirement information corresponding to the navigation mode includes: a frame rate interval includes frame rates of not less than 3 fps, and an image brightness parameter of an above-ground image area of an image is within a first image brightness interval, and image requirement information corresponding to the obstacle avoidance mode includes: a frame rate interval includes frame rates of not less than 10 fps, and an image brightness parameter of a ground image area of an image is within a second image brightness interval; and the first image brightness interval does not completely overlap with the second image brightness interval. The image acquisition assembly captures images at a frame rate of 25 fps by detecting the light intensity of the surrounding environment and generates a first image frame sequence, and the image acquisition assembly also uniformly extracts images from the first image frame sequence at a frame rate of 13 fps, wherein 3 frames of extracted images are confirmed to be images corresponding to the navigation mode as a frame rate interval of not less than 3 fps is satisfied, and 10 frames of extracted images are confirmed to be images corresponding to the obstacle avoidance mode as a frame rate interval of not less than 10 fps is satisfied; each extracted image corresponds to a functional mode with the same image requirement information; the image acquisition assembly also calculates a first image brightness parameter of the corresponding images corresponding to an image brightness processing method of the navigation mode, and compares the calculated first image brightness parameter with the first image brightness interval; and the image acquisition assembly also calculates a second image brightness parameter of the corresponding images corresponding to an image brightness processing method of the obstacle avoidance mode, and compares the calculated second image brightness parameter with the second image brightness interval; based on respective comparison results, the image brightness processing is/is not performed; and the image acquisition assembly outputs images meeting the image requirement information of the navigation mode and the obstacle avoidance mode based on a time series and at a frame rate of 13 fps. The image brightness processing method corresponding to the obstacle avoidance mode and the image brightness processing method corresponding to the navigation mode include, for example, a processing method of calculating an image brightness parameter using weight distributions corresponding to different functional modes as mentioned in the preceding example; and/or a processing method of performing image segmentation using the image areas corresponding to different functional modes and calculating an image brightness parameter of an area of interest after segmentation as mentioned in the preceding example.

In some applications, the image acquisition assembly not only performs image processing on the first image frame sequence based on the image requirement information, but also performs, for example, image correction processing on the first image frame sequence, and at least one of image segmentation, image denoising, image color correction, and image resolution adjustment on the images in the first image frame sequence to adapt to generic or specific requirements on overall image sharpness, data operation amount and the like in each power mode.

The image processing unit in the image acquisition assembly performs image segmentation processing in a manner that can be used to remove edge areas with large image distortions, or remove image areas with low definition, overexposure or underexposure, etc. For example, image segmentation is performed on the frames of images in the first image frame sequence according to a preset image size to remove edge areas with large image distortions at the periphery.

The image processing unit in the image acquisition assembly performs image denoising processing in a manner that can be used to reduce noise data, such as random noise of brightness in the image, that is not conducive to providing valid information. For example, the image acquisition assembly performs smoothing on the frames of images in the first image frame sequence by using a filter to overexposure, achieve the denoising purpose.

The image processing unit in the image acquisition assembly performs image color correction processing in a manner that can be conducive to improving the ability of identifying areas of interest in the images, etc. For example, the image acquisition assembly increases a color saturation or a color contrast by adjusting a gray histogram of the images.

The image processing unit in the image acquisition assembly performs image resolution processing in a manner that is used to reduce the amount of computation for subsequent image processing, etc. For example, the image acquisition assembly reduces the image resolution by downsampling.

The above examples of image processing may be combined with each other to achieve image pre-processing of the images in the first image frame sequence. Alternatively, some of the above image processing manners are combined with image requirement information of functional modes to output a second image frame sequence that can be used by the control system to perform processing based on requirements in different functional modes.

It is to be noted that the image requirement information corresponding to the multiple functional modes as previously described may be the same or different. For example, the image requirement information corresponding to the visual tracking mode and the obstacle avoidance mode is basically the same, the image requirement information corresponding to the navigation mode and the VSLAM mode is basically the same, and the image requirement information corresponding to the docking mode is not the same as that of the other modes. In pre-coordination with the control system, the control system executes a control method using the received second image frame sequence to control the movement device in the mobile robot, so that the mobile robot autonomously moves in a complex environment.

It is also to be noted that the above examples or applications may be used in combination with each other to facilitate the control system acquiring information inputs matching the functional mode being run functional mode from the images in the second from the images in the second image frame sequence. For example, the first image frame sequence provided by the image acquisition assembly is captured by detecting external ambient light; corresponding image processing is performed on an image in the first image frame sequence according to a frame rate interval, and an image brightness interval of an image area, in image requirement information corresponding to the functional mode; and a label for indicating the corresponding functional mode is added to the processed image. Hence, from each image in the received second image frame sequence, the control system confirms its relationship with each functional mode maintained.

The control system is arranged on the robot body to control driving wheels, and is usually provided with a processor and memory. In some embodiments, the control system is arranged on a circuit mainboard within the robot body and includes a memory and a processor, the memory and processor being electrically connected directly or indirectly to each other to achieve data transmission or interaction. Referring to FIG. 18, which shows a structural block diagram of the control system, the control system 7 includes an interface device 71, at least one memory 72, and at least one processor 73. The hardware of the control system 7 is, for example, a mainboard device centrally provided on a PCB circuit board.

The control system may further include at least one software module stored in the memory in the form of software or firmware. The software module is expressed by various programs for execution by the mobile robot, such as a route planning program of the mobile robot. The processor is configured to execute the program, thereby controlling the mobile robot to move autonomously.

In some embodiments, the processor includes an integrated circuit chip having signal processing capability; or a general-purpose processor, which may be, for example, a digital signal processor (DSP), an application-specific integrated circuit (ASIC), a discrete gate or transistor logic device, or a discrete hardware component, which can implement or perform the methods, steps, and logic block diagrams disclosed in embodiments of the present application. The general-purpose processor may be a microprocessor or any conventional processor or the like. In some embodiments, the memory may include a random access memory (RAM), a read only memory (ROM), a programmable read-only memory (PROM), an erasable programmable read-only memory (EPROM), an electric erasable programmable read-only memory (EEPROM), or the like. The memory is configured to store a program, and the processor executes the program after receiving an execution instruction.

The control system also includes an interface device. One or more interface devices may be provided. The interface devices are configured for connection with different environmental detection devices. For example, one of the interface devices is connected to an image acquisition assembly to receive images captured by the image acquisition assembly. Examples of the interface devices include at least one of serial interfaces such as USB interfaces, HDMI interfaces, RS232 interfaces, and parallel interfaces such as bus interfaces. The image acquisition assembly, the movement device and other hardware are connected to the processor and memory data through the interface devices. For example, the image acquisition assembly transmits the second image frame sequence to the control system through a USB interface for the processor to retrieve and process, and the image acquisition assembly is also connected to the control system through AHP and ABP buses to transmit control instructions, or perform high-speed data read and write operations with the processor. As another example, the movement device is in data connection with the control system through a USB interface to transmit traveling-related control instructions.

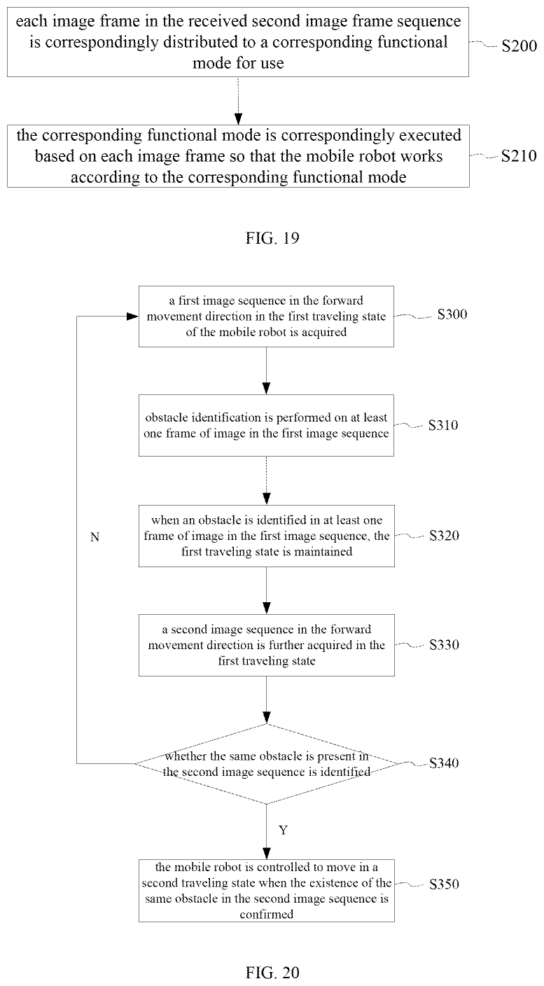

Please refer to FIG. 19, which shows a schematic flow diagram of a control method executed by the control system.

In step S200, each image frame in the received second image frame sequence is correspondingly distributed to a corresponding functional mode for use.

The control system maintains at least one functional mode, and each maintained functional mode uses corresponding images in the second image frame sequence as input information. The control system caches the received second image frame sequence and switches to one of the functional modes according to a preset polling mechanism and reads the corresponding images. This achieves a distribution operation of the images in the second image frame sequence. For example, the control system uses a process management method to maintain the functional modes that run as processes. The process management method includes, but is not limited to, at least one of the following: allocating computing resources for running the processes of the functional modes by polling the fragmented resources; running the processes of the corresponding functional modes sequentially according to an image order in the received second image frame sequence and the functional modes corresponding to the images; managing the processes of different functional modes by process management mechanisms such as interrupt, wake-up, and sleep; or managing the processes of different functional modes by using a preset priority mechanism. For example, the control system manages the functional modes by running a state machine. The state machine is an execution logic implemented by a software program, and is stored or built in the memory in the form of a software program.

In an example where the image acquisition assembly uses labels to mark the functional modes corresponding to images in the second image frame sequence, the control system determines functional modes corresponding to the corresponding images by parsing the labels and distributes them. For example, the received second image frame sequence includes images corresponding to all functional modes (or at least one functional mode determined according to a control instruction), and when running the process of a corresponding functional mode, the control system uses corresponding at least one frame of image as input information for running the same, according to the label of each image.

In an example where the image acquisition assembly outputs the second image frame sequence using an image output order pre-agreed with the control system, the control system determines functional modes of acquired images under the action of a synchronization mechanism according to the image output order, and distributes them. For example, the received second image frame sequence includes images corresponding to all functional modes (or at least one functional mode determined according to a control instruction), and the control system receives each image and determines a functional mode corresponding thereto based on a preset image transmission order according to a synchronization transmission channel established by the synchronization mechanism; and when running the process of the corresponding functional mode, uses corresponding at least one frame of image as input information for running the process.

In step S210, the corresponding functional mode is correspondingly executed based on each image frame so that the mobile robot works according to the corresponding functional mode.

When running the corresponding functional mode, the control system performs data processing by using at least the corresponding images to generate information for adjusting a traveling mode of the mobile robot, or to generate information for updating map data stored in the memory by performing a read/write operation.

In an example where the control system executes the VSLAM mode or the navigation mode by using images, the control system runs the corresponding functional mode in a manner that, for example: the control system reads multiple frames of images based on a corresponding frame rate interval; extracts matched landmark feature data from at least two frames of images; and calculates the current position of the mobile robot and/or the position of the landmark feature data in the images in the map data, based on the map data or physical scale data provided by other environment detection device in the mobile robot.

The landmark feature data is identification data in the images that is used to help the control system identify the physical environment where it is currently located. During a continuous movement of the mobile robot in the physical environment, accurate localization is performed by using landmark feature data in the acquired images iteratively. To reduce variations in the landmark feature data, the images received by the control system contain image areas generated based on above-ground image areas of multiple frames of images in the first image frame sequence. In other words, the control system performs localization calculation by using the landmark feature data based on the corresponding above-ground image areas in the images.

The other environmental detection device is a device used to detect the surrounding environment of the mobile robot, and/or to measure traveling data of the mobile robot. The other environmental detection device provides data including at least one type of the following depending on its assembly position on the mobile robot: data related to movement safety of the mobile robot; data related to movement orientation and movement distance of the mobile robot, etc.; and data that helps the mobile robot perceive the physical space where it is located, etc.; and the device includes but is not limited to: a cliff sensor, an infrared sensor, a laser sensor, and an inertial navigation sensor.

In some examples, the mobile robot uses data related to movement orientation and movement distance of the mobile robot provided by the other environmental detection device, and images provided by the image acquisition assembly to obtain distance data and angle data of the mobile robot. Here, based on images of a forward movement direction of the mobile robot provided by the image acquisition assembly, the control system determines a transformation relationship s (also called ratio scale) between a corresponding same physical object and landmark feature data corresponding to the physical object in image data by acquiring data provided by an environmental measurement device (or a movement measurement device) for at random-access least two locations, and then determines a relative position relationship between the mobile robot and the physical object reflected by the landmark feature data by using the transformation relationship.

In some specific examples, subject to the ground material when the mobile robot actually moves, to solve the problem that using distance data and angle data provided by the inertial navigation sensor alone is not conducive to accurate localization, the control system acquires the data from the inertial navigation sensor on the one hand, and also acquires image data provided by the image acquisition assembly on the other hand; and during movement, the control system acquires distance data and angle data from a position Pos1 to a position Pos2, and image data Pic1 and Pic2 captured at the two positions, respectively, wherein the image data Pic1 and Pic2 contain overlapping viewing angle areas, so the two frames of image data Pic1 and Pic2 correspond to image information of the same physical object (also called landmark feature data). The control system extracts a corresponding landmark feature data set by matching the two frames of image data Pic1 and Pic2, wherein the landmark feature data set contains landmark feature data Pic_Feature_1 and Pic_Feature_2 corresponding to the same solid object, namely the landmark feature data Pic_Feature_1 and Pic_Feature_2 are matched with each other, wherein the landmark feature data Pic_Feature_1 belongs to the image data Pic1, and the landmark feature data Pic_Feature_2 belongs to the image data Pic2. Using the distance data and the angle data between the positions Pos1 and Pos2 measured by the inertial navigation sensor, as well as the landmark feature data Pic_Feature_1 and Pic_Feature_2 and their image positions in the respective image data, the control system calculates a position relationship of the mobile robot relative to the physical object by using a spatial transformation (or matrix transformation) method.

At least one of the two frames of image data mentioned in the above example is from the second image frame sequence, and the other frame may be from the second image frame sequence or from the map data. When the two frames of images are both from the second image frame sequence, the control system performs autonomous movement in the VLSAM mode for the purpose of building the map data; and when the two frames of images are from the second image frame sequence and the map data, respectively, the control system performs autonomous movement in the navigation mode for the purpose of, for example, cleaning the ground, cruising, or transferring.

Like the maintenance of multiple functional modes, the control system also runs the obstacle avoidance mode during running of the VSLAM mode or the navigation mode, and performs obstacle detection using the images provided in the second image frame sequence during running of the obstacle avoidance mode. The obstacle detection at least includes: detecting, from an image, obstacle information describing an obstacle, and detecting a relative position relationship between the obstacle and the mobile robot. The obstacle information includes image features in the image describing the obstacle, and even includes the type of the obstacle identified from the image. Examples of the image features include an object outline, and/or texture identified from the obstacle image, etc., or image features extracted using an image classifier obtained by machine learning, etc. The obstacle type is information that can be identified by both the mobile robot and the user using the mobile robot and reflects the commodity attributes of the obstacle.

The control system calculates obstacle information in images corresponding to the obstacle avoidance mode in the second image frame sequence according to preset physical reference information. The physical reference information includes but is not limited to: a physical height of the camera device from a bottom face of the mobile robot, physical parameters of the camera device, and an included angle between a main optical axis of the camera device and a horizontal or vertical plane. The above-mentioned physical reference information is pre-stored in the memory, or obtained in advance by calculating design parameters of the mobile robot.

The control system confirms the fact that there is an obstacle in the forward movement direction of the mobile robot by identifying the obstacle information in a ground image area; performs calculation based on the physical reference information and the imaging principle, to determine a distance from the obstacle captured in the image to the mobile robot, and determine an orientation angle of the corresponding obstacle with respect to the mobile robot, thus obtaining a relative position relationship between the mobile robot and the obstacle. If the obtained relative position relationship indicates that the mobile robot is at risk of colliding with the obstacle, the control system performs an obstacle avoidance operation, such as moving at a reduced speed until it stops, or going around, according to the obstacle avoidance mode.

However, when data processing for obstacle avoidance control is performed using only the images provided by the image acquisition assembly, the control system is likely to send a control instruction that causes a misoperation of the mobile robot due to unavailability of depth data. For example, a pattern on the ground (such as a carpet pattern) is incorrectly recognized as an obstacle, and a detouring movement is performed, etc. This misoperation not only may leads to failure of the mobile robot to navigate to a target location, but is also unfavorable for the mobile robot to perform other operations synchronously during autonomous movement, such as reducing the cleaning coverage of a sweeping operation/mopping operation.

It needs to reduce redundant data detected by the mobile robot on the one hand, and to solve problems such as excessive or frequent braking caused by data reduction. Please refer to FIG. 20, which shows a flow diagram of a control method executed by the control system. The control system executes the control method when running the obstacle avoidance mode, and/or the visual tracking mode, during movement in a traveling state (i.e., a first traveling state) in a non-obstacle avoidance mode such as the navigation mode, the transfer mode or VSLAM mode.

In step S300, a first image sequence in the forward movement direction in the first traveling state of the mobile robot is acquired. The first traveling state is a moving state of the mobile robot in autonomous movement in a functional mode. The first image sequence is an image sequence formed by a plurality of frames of images corresponding to the obstacle avoidance mode, and/or the visual tracking mode in the second image frame sequence.

In step S310, obstacle identification is performed on at least one frame of image in the first image sequence. That is, the control system identifies from at least one frame of image in the first image sequence obstacles that hinder the movement of the mobile robot during performing a task. The task performed by the mobile robot is, for example, other operation performed during its autonomous movement or at the destination of the movement. In an example where the mobile robot is a sweeper, the task performed is to a task of vacuuming or mopping the floor performed during the movement. The obstacles that hinder the movement for performing the task may be all identified obstacles placed on a navigation route; or a limited types of obstacles on the navigation route. For example, the obstacles are at least one type of the following items placed on the navigation route: immovable obstacles; obstacles that are liable to entangle and trip up the mobile robot, such as data lines, plant vines, and other flexible entanglements; or obstacles that are unfavorable for the mobile robot to accomplish the task, such as shoes, flower pots, toys, and pet feces.

The control system identifies object information in an image, and confirms an image position of the identified object information in the image; and based on a position relationship between the image position and a ground image area, determines that the corresponding object information corresponds to an obstacle.

Here, the control system may identify the object information and its image position from a single frame of image in the first image sequence, or from a plurality of frames of images selected therefrom. Identifying object information in a single frame of image can effectively suppress the amount of computation and improve the response speed; identifying object information in multiple frames of images can reduce the misidentification rate.

In some examples, the control system selects from the first image sequence multiple frames of images for identifying object information and reconstructs three-dimensional data of the object by using the multiple frames of images, and determines corresponding object information and its image position in a frame of image based on the reconstructed three-dimensional data.

In some further examples, the control system identifies object information in a frame of image and its image position by an identification method of extracting edge lines in the image and identifying a connected component formed by the edge lines.

In some other examples, the control system confirms object information and its position information in an image by identifying at least one frame of image in the first image sequence using an image classifier. The image classifier contains an image processing logic trained by machine learning. The image classifier may acquire the ability to perceive what is and is not an object, or the ability to perceive object types, through a training process of machine learning. The object types may be types to be identified by the control system, for distinguishing objects as transferable/non-transferable. Alternatively, the object types are types to be agreed upon by the control system and user, for distinguishing categories of objects perceived by humans. For example, the object types include tables, chairs, entanglements, wall lines, balls, shoes, socks, flower pots, and toys. For example, the image classifier provides a confidence that an image area in an identified image is an object (or an object type) to indicate object information of the image area it identifies; and the control system evaluates the image area indicated by the image classifier as object information or non-object information based on the confidence.

To improve the accuracy of any of the identification methods described above, the control system pre-processes at least one frame of image before performing the identification operation. The pre-processing includes, but is not limited to, at least one of: image segmentation, image contrast adjustment, and resolution adjustment, as supplementary image processing that is not provided by the image acquisition assembly. For example, at least one frame of image is segmented to select an image portion mainly composed of a ground image area. As another example, domain transformation is performed on at least one frame of image, and image binarization is performed based on a histogram, to facilitate edge extraction in the subsequent identification operation, etc. As yet another example, downsampling is performed by operations such as convolution to reduce the amount of computation for subsequent image identification.

An actual object in the environment corresponding to the object information identified according to any of the above examples or a combination thereof is not necessarily an obstacle. Thus, the control system also confirms that the identified object information corresponds to an obstacle that hinders the movement of the mobile robot, according to a position relationship between the image position of the object information in the image and a ground image area in the image.

In some examples, according to an assembly elevation angle of the image acquisition assembly, a preset image area in an original image captured by the image acquisition assembly is set as the ground image area. For example, the control system segments images in the first image sequence according to the preset ground image area, and identifies object information contained in the ground image area, thereby confirming that objects corresponding to the identified object information are all located on the ground.

In some other examples, considering that the sizes of the ground image areas in the original images captured by the image acquisition assembly are variable as the mobile robot moves to a position close to or away from a tall obstacle such as a wall, the control system identifies the ground image area in the at least one frame of image; and the control system determines whether the object corresponding to the object information is placed on the ground, based on a position relationship between the identified ground image area and the object image area where the object information is located.

If the image sizes of the images provided by the image acquisition assembly are unmodified, the control system identifies the ground image areas in the images based on preset ground feature information. The ground feature information may be pre-stored image features reflecting various ground. Alternatively, the ground feature information is extracted by the control system from image edge areas of the images. The image boundary area is preset according to physical parameters such as the height of the position of the image acquisition assembly assembled on the mobile robot, the direction of its optical axis, and a field angle. The control system extracts ground feature information from a sub-area of the image boundary area that does not overlap with the object image area corresponding to the object information, and thereby determines the ground image area in the image. The control system determines the ground image area in the image by calculating the distribution of the ground feature information in the image. For example, the ground image area is determined based on the percentage of the distribution.

The control system confirms whether the object corresponding to the identified object information is placed on the ground by determining a degree of overlap between the image position of the identified object information and the ground image area.

In some examples, the control system determines whether the lowest point of the object image area of the identified object information is located in the ground image area, and if so, determines whether the object corresponding to the corresponding object information is considered as an obstacle placed on the ground, and if not, reacquires an image in the first image sequence.

In some other examples, the control system determines whether the percentage of the sub-area of the object image area of the identified object information that overlaps with the ground image area is greater than a preset percentage threshold, and if so, determines whether the object corresponding to the corresponding object information is considered as an obstacle placed on the ground, and if not, reacquires an image in the first image sequence.

To reduce information deviation between information in the forward movement direction provided by the images, and information related to obstacles in the forward movement direction required for the obstacle avoidance mode, when the control system confirms there is an obstacle in the forward movement direction by identifying at least one frame of image in the first image sequence, the control system does not perform a corresponding traveling operation according to the obstacle avoidance mode, but continues to move forward along the navigation route in the first traveling state.

For the control system, a traveling state is adjusted in the obstacle avoidance mode, so that the mobile robot performs a movement behavior such as turn-around avoidance and detouring. Since the control system may not be able to distinguish between a window frame shadow/carpet pattern and an edge of an obstacle in an image when identifying data in the image, resulting in misidentification, image features in one or more frames of images are incorrectly determined an image features of an obstacle, and thus, the control system performs step S320 when determining the existence of object information corresponding to an obstacle in at least one frame of image in the first image sequence. In other words, in step S320, when an obstacle is identified in at least one frame of image in the first image sequence, the first traveling state is maintained to reduce the possibility of immediately responding to the obstacle avoidance mode and performing a movement behavior related to obstacle avoidance.

In some examples, when the control system is in the visual tracking mode, triggered by an identification result that there is an obstacle in the forward movement direction as reflected by at least one frame of image in the first image sequence, the control system proceeds to steps S330 and S340, and triggered by another event in step S340, switches to the obstacle avoidance mode to perform step S350 or re-perform step S300.

In some other examples, the control system still maintains the traveling state of the current functional mode (e.g., navigation mode, or VLSAM mode), proceeds to steps S330 and S340, and triggered by another event in step S340, performs step S350 or re-performs step S300.

In step S330, a second image sequence in the forward movement direction is further acquired in the first traveling state. The second image sequence is acquired after the first image sequence and in the same manner as the first image sequence was acquired. There are no overlapping images between the second image sequence and the first image sequence; or in order to track the image positions of the object information corresponding to the obstacle in the different images, the first several consecutive frames of images in the second image sequence are overlapped with the last several consecutive frames (or non-consecutive frames) of images in the first image sequence.

In step S340, whether the same obstacle is present in the second image sequence is identified, and if yes, step S350 is performed, and otherwise, it returns to step S300.

Here, the control system uses the object information corresponding to the obstacle in the first image sequence to match at least one frame of image in the second image sequence to obtain the obstacle identified in step S310. In other words, the control system identifies the same obstacle in the second image sequence as in the first image sequence.

In some examples, the control system identifies an obstacle from at least one image in the second image sequence; and matches image features of the obstacle obtained in step S310 with those of the obstacle obtained in this step to obtain an identification result of the same obstacle. The method of identifying the obstacle from at least one image in the second image sequence may be the same as or similar to the identification method adopted in step S310, or different from the identification method adopted in step S310. For example, in step S310, the control system identifies the object information of the obstacle by using an image classifier, and in step S340 the control system identifies the object information of the obstacle by using the image features. As another example, in both step S310 and step S340, the control system identifies the object information of the obstacle by using an image classifier.

The control system confirms whether an obstacle is placed in the forward movement direction of the mobile robot by multiple times of image identification at different moments, thereby reducing the possibility of the mobile robot performing an obstacle avoidance operation in the obstacle avoidance mode by mistake.

In some other examples, the control system performs visual tracking on at least one frame of image in the second image sequence according to the obstacle identified in the first image sequence.

The control system determines a tracking range of the same object corresponding to at least one frame of image in the second image sequence according to the forward movement direction, and obtains a recognition result of the same obstacle from the tracking range.

In some specific examples, the forward movement direction is determined based on inertial navigation data that reflects the overall movement of the mobile robot provided by an inertial navigation sensor arranged in a movement device of the mobile robot. The inertial navigation data includes displacement data indicating a movement distance and angular data indicating an attitude change. For example, the control system determines a turning direction or traveling straight, based on the angle data in the inertial navigation data.

In some other specific examples, the forward movement direction is predicted based on position changes of the same image feature in multiple frames of images in the first image sequence. The tracking range is an image area of an image feature in at least one frame of image in the second image sequence predicted based on position changes of the same image feature in multiple frames of images in the first image sequence. The image feature is, for example, any image feature in the first image frame sequence. For example, the image feature is an image feature corresponding to the obstacle identified in step S320.

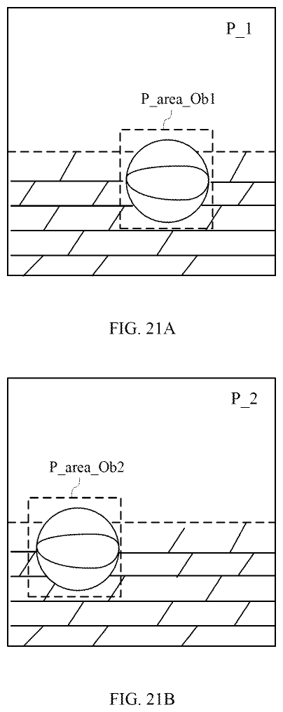

In an example in which the tracking range is obtained based on mirror symmetry (or consistency) between an object that falls within the viewing angle range of the image acquisition assembly in the environment where the mobile robot is located and corresponding image positions of the object in the output images, when the mobile robot is moving straight, as the mobile robot spatially gets closer to the object, the image positions of the object Ob1 in successive frames of images are in an orientation changing relationship of moving toward side edges of the images. Please refer to FIGS. 21A and 21B, which show the same object corresponding to different image positions in the two frames of images when the mobile robot turns right. When the mobile robot turns right, as the spatial orientation between the mobile robot and the object changes, the image positions of the object Ob1 in the successive frames of image P_1 are in an orientation change relationship of moving from an image position P_area_Ob1 in the previous image toward the left side of the image, i.e., being located at an image position P_area_Ob2 in the subsequent image P_2. Correspondingly, the control system confirms the corresponding tracking ranges in the images in the second image sequence based on the forward movement direction and the object information and image positions of the obstacle in the first image sequence. When the control system finds object information, within the tracking ranges of the images in the second image sequence, matched with the object information of the obstacle identified in the first image sequence, step S350 is performed; conversely, step S300 is performed.

In step S350, the mobile robot is controlled to move in a second traveling state when the existence of the same obstacle in the second image sequence is confirmed.

The control system will perform a traveling operation according to the obstacle avoidance mode when confirming the existence of the same obstacle in the second image sequence. In the obstacle avoidance mode, the control system adjusts the traveling state from the first traveling state to the second traveling state. The second traveling state pertains to the obstacle avoidance mode. The first traveling state differs from the second traveling state based on a change in at least one of traveling speed, traveling direction, and traveling route. For example, the first traveling state includes a first traveling speed, and the second traveling state includes a second traveling speed, wherein the second traveling speed is less than the first traveling speed. As another example, the first traveling state includes a first traveling direction, and the second traveling state includes a second traveling direction, wherein the second traveling direction differs from the first traveling direction to avoid obstacles.

In some examples, in accordance with a preset second traveling state in an obstacle avoidance state, the control system controls the mobile robot to move in the second traveling state in the case of state switching. For example, in the obstacle avoidance state, the control system performs a reduced speed movement in the preset second traveling state.

In some further examples, the control system determines a second traveling state based on a position relationship between the mobile robot and the obstacle.

In some specific examples, the position relationship is determined based on changes between image positions in multiple frames of images corresponding to the obstacle. The multiple frames of images are from the first image sequence and the second image sequence.

For example, the control system, during acquisition of the first image sequence and the second image sequence, also acquires measurement data provided by other environmental detection devices for determining at least a movement distance, and calculates the position relationship between the mobile robot and the obstacle by using the acquired measurement data, and the image positions corresponding to the obstacle in the corresponding frames of images. The measurement data may also include a movement angle.

In an example in which the other environmental detection devices include a counting sensor and an angle sensor arranged on any of a drive motor, rollers, or a mechanical structure between the drive motor and the rollers, the drive motor is mechanically connected to the rollers of the mobile robot, and includes a first motor for driving the rollers to rotate in a tangential direction, and a second motor for driving some of the rollers to rotate in a non-tangential direction. The first motor and the second motor are independent motors or integrated motors. The counting sensor is configured to measure the number of revolutions of the first motor, and the mobile robot determines a movement distance of the movement of the mobile robot by a preset circumference of the rollers and an acquired number of revolutions. The angle sensor is configured to measure an angle of movement of the second motor with respect to an initial position. The initial position, for example, corresponds to a deflection angle value of the rollers when the mobile robot is in an initial direction, or corresponds to a middle value of a rotation range of the second motor, or any end point value of the rotation range. The initial position and the initial direction are, for example, a position and a direction at the last measurement.

In an example in which the other environmental detection devices include a velocity sensor and an angular velocity sensor (or gyroscope) arranged on the mobile robot, the mobile robot reads, per unit time, velocity values and angular velocity values, etc. provided by the other environmental detection devices, and calculates a movement distance and a movement angle from a position Pos1 to a position Pos2 by using the velocity values and the angular velocity values per unit time.

In some further specific examples, the position relationship is calculated based on preset physical parameters. The physical parameters include internal parameters of the image acquisition assembly such as a viewing angle and a focal length of a lens set, and external parameters such as an assembly elevation angle and an assembly height with the assembled image acquisition assembly. The control system calculates the position relationship between the mobile robot and the obstacle according to the physical parameters and the image position in at least one frame of image.

Based on any of the above examples, the mobile robot calculates the position relationship between the mobile robot and the obstacle, i.e., a relative distance and a relative angle, according to a transformation relationship between an image coordinate system constructed using the movement distance and the image positions corresponding to the obstacle in the corresponding frames of image, and a physical spatial coordinate system. For example, if the relative distance is less than a preset distance threshold, then a deceleration operation and a braking operation are performed, i.e., adjusting to a second traveling state that starts with the second traveling speed as an initial speed and continues to decelerate until stop. The second traveling speed is lower than the first traveling speed in the first traveling state. If the relative distance is greater than the preset distance threshold, a detour route is generated according to the position relationship and a detour operation is performed according to the detour route, i.e., adjusting, according to the detour route, to the second traveling state including the second traveling direction.

In practical applications, the mobile robot does not necessarily bypass identified obstacles. Using a sweeping robot as an example, objects such as balls and shoes are often placed on the ground, and if the objects are always avoided, it is not conducive for the sweeping robot to improve its coverage of cleaning the floor and its execution efficiency. Thus, in the present application, the following step S360 is also performed during low-speed traveling in the obstacle avoidance mode.

In step S360, movement control is performed on the mobile robot by detecting collision information between the mobile robot and the obstacle.

During movement in the second traveling state at a low-level speed, the control system detects the collision information (e.g., a pressure signal) between the mobile robot and the obstacle. When the collision information is detected, the mobile robot is controlled to continue pushing the obstacle to move.

For example, when the collision information is detected, movement data is still detected, and if the movement data indicates that the mobile robot is still moving, the obstacle is determined to be a transferable obstacle. The control system moves in a traveling state in the transfer mode. Using a sweeper as an example, the control system travels a preset distance at a low speed in the transfer mode and then turns and travels to clear a ground area before the obstacle is transferred.

The present application uses image sequences provided by the image acquisition assembly to provide input data for multiple functional modes, and also uses a method of multiple confirmations of an obstacle, to solve the problem of inconsistency of data confidence between the obstacle avoidance mode and other functional modes that use images as input data. In addition, adjusting the traveling state in the case of confirming the obstacle multiple times using the image sequences can effectively reduce the probability of misoperations such as braking and detouring in the obstacle avoidance mode.

In the description of the above examples, the control system changes a traveling mode of the mobile robot by controlling a movement device in the mobile robot. Therefore, in addition to the image acquisition assembly and control system described above in FIGS. 2-10 assembled on the mobile robot, the mobile robot also includes a movement device, and a hardware device such as a power supply device for the operation of electrical devices.

The power supply device includes a battery module, which is built in the robot body to supply power to other power-using devices (e.g., the movement device, and a cleaning device). In practical applications, the battery module includes a rechargeable battery pack, and may use conventional nickel-metal hydride batteries, which are economical and reliable, but the battery module is not limited thereto. The battery module may also use lithium batteries. Compared with nickel-metal hydride batteries, lithium batteries have higher volumetric specific energy than nickel-metal hydride batteries, and the lithium batteries have no memory effect and can be changed for use at any time, so the convenience is greatly improved. Of course, in practice, in addition to using rechargeable batteries, the battery module may also be used in combination with solar cells. In addition, if necessary, the battery module may include a main battery and a backup battery. When the main battery is low or fails, the backup battery may operate instead. The battery module is mounted in a battery recess in the chassis. The size of the battery recess may be customized according to the battery module mounted therein. The battery module may be mounted in the battery recess by conventional means, such as a spring latch. The battery recess is closed by a battery cover plate, and the battery cover plate may be fixed to the chassis by conventional means, such as a screw.

The movement device includes driving wheels (not shown) arranged on two opposite sides of the robot body to drive the robot body into motion. The driving wheels are mounted along two opposite sides of the chassis, and the driving wheels are usually arranged on a rear side of a dust suction port, so that the dust suction port is located on a front side of the robot body, thereby providing space for designing a longer dust suction channel. The driving wheels are configured to drive the cleaning robot to perform front-back reciprocating movement, rotating movement, curved movement or the like according to a planned motion trajectory, or to drive the cleaning robot to adjust its attitude, and provide two contact points between the robot body and the floor surface. The driving wheels may have a bias drop suspension system, which is fastened in a removable manner, such as being mounted to the robot body in a rotatable manner, and receives a spring bias downward and away from the robot body. The spring bias allows the driving wheels to maintain contact and traction with the ground with a ground-touching force to ensure tire surfaces of the driving wheels are in full contact with the ground. In the present application, when the cleaning robot needs to turn or walk in a curve, a speed difference of the driving wheels on both sides that drive the robot body into motion is adjusted to achieve steering.

In an embodiment, the robot body may also be provided with at least one driven wheel (in some embodiments, the driven wheel is also referred to as an auxiliary wheel, a caster wheel, a roller, a universal wheel, or the like) to stably support the robot body. In an embodiment, two driven wheels are provided, and are arranged on rear sides of the driving wheels, respectively, and are used together with the driving wheels on both sides of the robot body to keep the balance of the robot body in a motion state.

To drive the driving wheels and the driven wheels into operation, the movement device also includes a drive motor, and a control system that controls the drive motor. A drive circuit controlling the drive motor is electrically connected to the control system. The drive motor can be used to drive the driving wheels to achieve movement. In specific implementation, the drive motor may be, for example, a reversible drive motor.

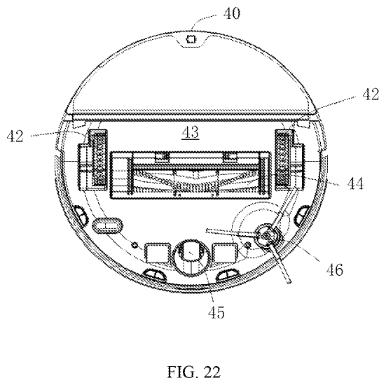

In an example in which the mobile robot is a cleaning robot, please refer to FIG. 22, which shows a bottom-view diagram of the mobile robot in an embodiment. As shown in the figure, the driving wheels 42 are mounted along two opposite sides of the chassis 43, and as shown in the figure, the driving wheels 42 are usually arranged on a rear side of a dust suction port 44. The driving wheels are configured to drive the mobile robot to perform front-back reciprocating movement, rotating movement, curved movement or the like according to a planned motion trajectory, or to drive the mobile robot to adjust its attitude. In embodiments, the driving wheels 42 may have a bias drop suspension system, which is fastened in a removable manner, such as being mounted to the body 40 of the mobile robot in a rotatable manner, and receives a spring bias (not marked with a numeral) downward and away from the body 40. The spring bias allows the driving wheels 42 to maintain contact and traction with the ground with a ground-touching force to ensure tire surfaces of the driving wheels 42 are in full contact with the ground. In the present application, when the mobile robot needs to turn or walk in a curve, a speed difference of the driving wheels 42 on both sides that drive the body 40 into motion is used to achieve steering.

In some embodiments, the body 40 may also be provided with at least one driven wheel 45 (in some embodiments, the driven wheel is also referred to as an auxiliary wheel, a caster wheel, a roller, a universal wheel, or the like) to stably support the body. For example, as shown in FIG. 22, a driven wheel 45 is provided on the body 40 of the mobile robot, and are used together with the driving wheels 42 on both sides of the body 40 to keep the balance of the body 40 in a motion state.

In consideration of the overall counter balance of the mobile robot, the driving wheels 42 and drive motors thereof in the movement device, and a fan portion (not shown in the figure) and a battery portion (not shown in the figure) of a modular dust suction assembly are located in a front part and a rear part of the body 40 of the mobile robot, respectively, so that the weight of the entire mobile robot is balanced when the dust suction assembly is assembled on the main body.

To drive the driving wheels 42 and the driven wheel 45 (driven wheel 45 is a passive wheel), the movement system also includes a drive motor (not shown in the figure). The mobile robot may also include at least one drive unit, such as a left wheel drive unit for driving the driving wheel on the left side and a right wheel drive unit for driving the driving wheel on the right side. The drive unit may include one or more processors (CPUs) or micro-processing units (MCUs) dedicated to controlling the drive motor. For example, the micro-processing control is configured to convert information or data provided by the control system into an electrical signal for controlling the drive motor, and controls a rotation speed, rotating direction, and the like of the drive motor according to the electrical signal to adjust a moving speed and moving direction of the mobile robot. The information or data is, for example, a deflection angle determined by the control system. The processor in the drive unit and a processor in the control system be a shared one or may be provided independently. For example, the drive unit serves as a slave processing apparatus, the control system serves as a master apparatus, and the drive unit controls the movement based on control of the control system. Alternatively, the processor in the drive unit and the processor in the control system are a shared one. The drive unit receives data provided by the control system through a program interface. The drive unit is configured to control the driving wheels based on a movement control instruction provided by the control system.

To protect the mobile robot, as shown in FIG. 2, a buffer assembly 101 is also provided on a front side of the robot body. During actual operation of the mobile robot, the buffer assembly 101 is configured to absorb and dissipate an impact force against an obstacle, thereby achieving protection of the mobile robot. In some embodiments, the buffer assembly may be, for example, a bumper to cushion the mobile robot from collision with surrounding objects during movement. The bumper may be mounted at a forward-facing portion of a side panel of the housing of the robot body 1.

The buffer assembly 101 may be integrally formed by a material such as plastic, which includes polyvinyl chloride (PVC), polyethylene (PE), polypropylene (PP), polystyrene (PS), polycarbonate (PC), acrylonitrile-butadiene-styrene plastic (ABS), polyurethane, polyamide, and thermoplastic elastomer, but is not limited thereto. The be integrally shape and size of the buffer assembly 101 are matched with the shape and size of the front side of the robot body. For example, the robot body is of an overall flat cylindrical structure, so the buffer assembly 101 is in the form of an arc piece. The buffer assembly 101 may include a structure such as a clamping slot, a groove or a hole that is formed in advance, to movably arrange the buffer assembly 101 on the front side of the robot body.

An elastic structure may be provided between the bumper and the robot body 1 so that a retractable resilient space is formed therebetween. When the mobile robot collides with an obstacle, the bumper contracts toward the robot body 1 under force, and absorbs and dissipates the impact force generated by the collision with the obstacle, thereby protecting the mobile robot. In some embodiments, the bumper may be of a multi-layer structure, or a soft rubber strip or the like may also be provided on the outer side of the bumper.

In an example in which the mobile robot is a cleaning robot, the mobile robot also includes a cleaning device. The cleaning device may at least include a dust suction assembly and a sweeping assembly.

The dust suction assembly is installed in the internal space, and has an air intake channel for dust suction under negative pressure through the dust suction port. The dust suction assembly includes a dust suction fan, an air duct structure, and a dust collection chamber.

The dust suction fan has a fan air inlet and a fan air outlet, wherein the air inlet of the dust suction fan is communicated with an air outlet of the integrally dust collection chamber through a connection channel, and the integrally fan air outlet is communicated with an air exhaust channel. Thus, the air duct structure described in the present application may at least include the air intake channel communicating the dust suction port to the dust collection chamber, the connection channel between the dust collection chamber and the dust suction fan, and the air exhaust channel communicated with the fan air outlet of the dust suction fan. The air exhaust channel may be fixed to the housing by means of a mounting structure, which in some embodiments may be, for example, a screw locking attachment.

In practical applications, a fan motor in the dust suction fan drives the fan to rotate so that an air stream mixed with garbage enters the dust collection chamber through the air intake channel via the dust suction port, the garbage in the air stream is filtered and retained in the dust collection chamber, and the filtered air stream enters the dust suction fan through the connection channel, and then is discharged from the fan air outlet of the dust suction fan through the air exhaust channel to the outside of the cleaning robot. In the air exhaust channel, most of the air stream flows in a main channel, but in corners or in areas of rapid air flow of the air exhaust channel, part of the air stream is dispersed to a secondary channel at a lateral side through an exhaust air guide element and flows in the secondary channel and then back to the main channel through the exhaust air guide element, which achieves a good diversion and guide effect for the air stream. The air exhaust channel so formed is long overall, which is conducive to eliminating noise, and the air stream is finally discharged to the outside of the cleaning robot, so that the cleaning robot itself can form a relatively closed space and dust is not liable to enter the interior of the cleaning robot. In addition, an air exhaust port of the air exhaust channel is of a gradually splaying structure, which is also more conducive to discharging air and can achieve an effect reducing air noise.

The dust collection chamber is provided on the robot body, and includes an air inlet port communicated with the dust suction port, an accommodating cavity for mounting a disposable filter bag, an air inlet port communicated with the dust suction assembly, and a cover for closing the accommodating cavity, wherein a clamping structure for adapting to the disposable filter bag is provided at the circumference of the air inlet port. In embodiments, a seal ring is provided at the air inlet port.

The dust suction port is located at a bottom surface of the cleaning robot and is open toward a surface to be cleaned. In some embodiments, the dust suction port is provided on a front side of the robot body so that the cleaning robot contacts dirt such as dust and scraps more quickly and collects the dirt through the dust suction port. The dirt includes, but is not limited to: soft scraps, clumps, strips, and hard scraps. The soft scraps include, for example, paper scraps, plastic pieces, and dust. The clumps include, for example, hair clumps, and plastic bags. The strips include, for example, electric wires, thread residues, iron wires, and strips of cloth. The hard scraps include, for example, rice grains, paper clips, stones, pens and other scraps often produced in residential and office environments, and exhaustion of examples is not provided here. Various dirt is usually smaller in size than the diameter of the dust suction port and can enter the cleaning device of the cleaning robot with the air flow.

The cleaning assembly may include a side brush (also called lateral brush or side sweeping brush) located on at least one side of the bottom of the housing, and a side brush motor for controlling the cleaning side brush, wherein the side brush may be a rotary side brush that can be controlled by the side brush motor to rotate. The side brush may extend beyond a side surface and a front surface of the cleaning robot body to agitate debris around wall corners and furniture, for example. The cleaning robot concentrates debris on the ground such as hair, dust and debris to the center of the traveling route of the cleaning robot by rotation of the side brush, and then stirs up the debris on the ground by rotation of a roller brush, so that the fan can suck the debris on the ground into the dust suction port by a suction force to perform cleaning, and dust suction and collection work.

To improve the dust suction capacity, the sweeping assembly in the current cleaning robot is usually equipped with both a side brush and a roller brush. The side brush is liable to collide with wall corners, furniture, obstacles and the like and prone to wear and tear due to partially extending beyond the body of the cleaning robot. The roller brush, also known as a cleaning roller or middle sweeping brush, may be arranged in a central area of the chassis of the cleaning robot. Usually, the roller brush is provided with bristles, scrapers or the like, and when the cleaning robot is working, the roller brush rotates to cause the bristles or scrapers to rotate. To better adsorb debris on the ground, the bristles or scrapers need to contact the ground.

The present application also provides a computer readable storage medium, which stores at least one program. The at least one program, when invoked by a processor, executes and implements the control method in any implementation of the embodiment shown in FIG. 11, 12, 14, or 20 and the corresponding description.

The functions may be stored in the computer readable storage medium if implemented in the form of a software functional unit and sold or used as a separate product. With this understanding, the technical solutions of the present application, in essence or for the part contributing to the prior art or for part of the technical solutions, may be embodied in the form of a software product, and the computer software product is stored in a storage medium, and includes a number of instructions configured to cause a computer device (which may be a personal computer, a server, a network device or the like) to execute all or part of the steps of the method described in the embodiments of the present application.

In the embodiments provided in the present application, the computer readable and writable storage medium may include a read only memory, a random access memory, an EEPROM, a CD-ROM or other optical disk storage device, a magnetic disk storage device or other magnetic storage device, a flash memory, a USB flash disk, a mobile hard disk or any other medium that can be used to store desired program codes in the form of instructions or data and that can be accessed by a computer. Furthermore, any connection can be properly called a computer readable medium. For example, if the instructions are transmitted from a website, server, or other remote source using a coaxial cable, fiber optic cable, twisted pair, digital subscriber line (DSL), or wireless technology such as infrared, radio, and microwave technology, the coaxial cable, fiber optic cable, twisted pair, DSL, or wireless technology such as infrared, radio, and microwave technology are included in the definition of the medium. However, it should be understood that the computer readable and writable storage medium and the data storage medium do not include connection, carrier, signal, or other transitory media, but are directed to non-transitory, tangible storage media. Magnetic disks and optical disks as used in the present application include compact disks (CDs), laser disks, optical disks, digital versatile disks (DVDs), floppy disks and Blu-ray disks, wherein a magnetic disk typically magnetically replicates data while an optical disk optically replicates data using laser.

In one or more exemplary aspects, the functions described in the computer program for the control method in the present application may be embodied in hardware, software, firmware, or any combination thereof. When embodied in software, the functions may be stored or transferred to a computer readable medium as one or more instructions or codes. Steps of methods or algorithms disclosed in the present application may be embodied in a processor executable software module, wherein the processor executable software module may be located on a tangible, non-transitory computer readable and writable storage medium. The tangible, non-transitory computer readable and writable storage medium may be any available medium accessible to a computer.

The flow diagrams and block diagrams in the above-mentioned drawings of the present application illustrate the architecture, functions, and operations of possible implementations of the system, method and computer program product according to various embodiments of the present application. In this regard, each block in the flow diagrams or block diagrams may represent a module, a program segment, or a portion of codes, and the module, the program segment, or the portion of codes contains one or more executable instructions for implementing a specified logical function. It should also be noted that in some alternative implementations, the functions indicated in the blocks may also occur in a different order from that indicated in the drawings. For example, two consecutively drawn blocks may actually be executed substantially in parallel, or sometimes in the reverse order, depending on the function involved. It should also be noted that each block in the block diagrams and/or flow diagram, and combinations of blocks in the block diagrams and/or flow diagram, may be implemented by a dedicated, hardware-based system that performs a specified function or operation, or may be implemented by a combination of special hardware and computer instructions.

Based on the above description of the examples, the present application provides various embodiments. Embodiments disclosed in the present application include:

1. An image processing method, the image processing method including the following steps:

acquiring an image frame captured by an image acquisition assembly provided on a mobile robot, wherein the image frame is applied in at least one functional mode of the mobile robot; and

comparing an image brightness parameter of the image frame with a target brightness parameter of the applied functional mode and adjusting the image brightness of the image frame if the image brightness parameter of the image frame is not matched with the target brightness parameter.

2. The image processing method according to embodiment 1, wherein the step of adjusting the image brightness includes: adjusting an image gain of the corresponding image frame, and/or adjusting a brightness contrast of the corresponding image frame.

3. The image processing method according to embodiment 1, wherein an exposure is adjusted by the image acquisition assembly according to the light in the environment during photographing.

4. The image processing method according to embodiment 1, wherein a horizontal field angle with which the image acquisition assembly captures the image frame sequence is 110° to 130°, and a vertical field angle with which the image acquisition assembly captures the image frame sequence is 80° to 100°.

5. The image processing method according to embodiment 1, wherein the functional mode includes at least one of visual localization and mapping, obstacle avoidance, visual docking, visual scene understanding, and visual tracking.

6. The image processing method according to embodiment 1, wherein the step of comparing an image brightness parameter of the image frame with a target brightness parameter of the applied functional mode includes: calculating the image brightness parameter of the image frame based on an area of interest corresponding to each functional mode and a weight value thereof.

7. The image processing method according to embodiment 6, wherein the step of calculating the image brightness parameter of the image frame based on an area of interest corresponding to each functional mode and a weight value thereof includes:

dividing the image frame into blocks with the area of interest as a unit; and

calculating the image brightness parameter of the image frame based on a weight value corresponding to the position of each area of interest in an image.

8. The image processing method according to embodiment 6, wherein in a functional mode of obstacle avoidance or visual tracking, a weight value in a ground image area is higher than a weight value in an above-ground image area; in a functional mode of visual localization and mapping, a weight value in the ground image area is lower than a weight value in the above-ground image area; or in a visual docking mode, a weight value in a middle area of the image is higher than a weight value in a surrounding area of the image.

9. The image processing method according to embodiment 1, wherein the method further includes: performing at least one of image segmentation, image denoising, image color correction, and image resolution adjustment on the image frame.

10. The image processing method according to embodiment 1, further including a step of outputting an image frame after being compared and processed according to a frame rate requirement corresponding to the corresponding functional mode.

11. The image processing method according to embodiment 10, wherein an acquisition frame rate of the image frame applied to a functional mode of visual localization and mapping or visual scene understanding is not less than 2 frames per second; and an acquisition frame rate of the image frame applied to a functional mode of obstacle avoidance or visual tracking is not less than 7 frames per second.

12. An image processing chip, configured to perform the image processing method according to any one of embodiments 1 to 11.

13. An image processing method, applied to an image acquisition assembly provided on a mobile robot, the image processing method including the following steps:

capturing a first image frame sequence based on a time series; and

outputting a second image frame sequence based on the first image frame sequence, wherein each image frame in the second image frame sequence is correspondingly for use in at least one functional mode of the mobile robot, respectively, and an image brightness parameter of each image frame in the second image frame sequence is matched with a target brightness parameter of the used at least one functional mode.

14. The image processing method according to embodiment 13, wherein the step of capturing a first image frame sequence based on a time series includes: adjusting the exposure during photographing according to the light in the environment where the image acquisition assembly is located to capture the first image frame sequence.

15. The image processing method according to embodiment 13, wherein the functional mode includes at least one of visual localization and mapping, obstacle avoidance, visual docking, visual scene understanding, and visual tracking.

16. The image processing method according to embodiment 13, wherein the step of outputting a second image frame sequence based on the first image frame sequence includes:

comparing an image brightness parameter of each image frame in the first image frame sequence with the target brightness parameter of the applied functional mode, and adjusting the image brightness of each image frame to output the second image frame sequence if the image brightness parameter of the image frame in the first image frame sequence is not matched with the target brightness parameter.

17. The image processing method according to embodiment 16, wherein the step of adjusting the image brightness of each image frame is implemented by adjusting an image gain of the image frame, and/or adjusting a brightness contrast of the corresponding image frame.

18. The image processing method according to embodiment 16, wherein the step of comparing an image brightness parameter of the image frame with the target brightness parameter of the applied functional mode includes: calculating an image brightness parameter of the image frame based on an area of interest corresponding to each functional mode and a weight value thereof.

19. The image processing method according to embodiment 18, wherein the step of calculating the image brightness parameter of the image frame based on an area of interest corresponding to each functional mode and a weight value thereof includes:

dividing the image frame into blocks with the area of interest as a unit; and

calculating the image brightness parameter of the image frame based on a weight value corresponding to the position of each area of interest in an image.

20. The image processing method according to embodiment 18, wherein in a functional mode of obstacle avoidance or visual tracking, a weight value in a ground image area is higher than a weight value in an above-ground image area; in a functional mode of visual localization and mapping, a weight value in the ground image area is lower than a weight value in the above-ground image area; or in a visual docking mode, a weight value in a middle area of the image is higher than a weight value in a surrounding area of the image.

21. The image processing method according to embodiment 13, wherein a horizontal field angle with which the image acquisition assembly captures the image frame sequence is 110° to 130°, and a vertical field angle with which the image acquisition assembly captures the image frame sequence is 80° to 100°.

22. The image processing method according to embodiment 13, further including: performing at least one of image segmentation, image denoising, image color correction, and image resolution adjustment on each image frame in the first image frame sequence.

23. The image processing method according to embodiment 13, wherein each image frame in the second image frame sequence is arranged according to frame rate requirement corresponding to the respective function mode.

24. The image processing method according to embodiment 23, wherein an output frame rate of each image frame applied to a functional mode of visual localization and mapping or visual scene understanding in the second image frame sequence is not less than 2 frames per second; and an output frame rate of each image frame applied to a functional mode of obstacle avoidance or visual tracking in the second image frame sequence is not less than 7 frames per second.

25. A visual control device, including:

a control unit, connected with a vision acquisition device and configured to control the vision acquisition device to capture a first image frame sequence; and

an image processing unit, connected with the control unit and configured to output a second image frame sequence based on the first image frame sequence,

wherein each image frame in the second image frame sequence is correspondingly for use in at least one functional mode of the mobile robot, respectively, and an image brightness parameter of each image frame in the second image frame sequence is matched with a target brightness parameter of the used at least one functional mode.

26. The visual control device according to embodiment 25, wherein the control on the vision acquisition device by the control unit includes at least one of frame rate control, resolution control, focus control, and automatic exposure control.

27. The visual control device according to embodiment 25, wherein the functional mode includes at least one of visual localization and mapping, obstacle avoidance, visual docking, visual scene understanding, and visual tracking.

28. The visual control device according to embodiment 25, wherein the image processing unit is configured to compare an image brightness parameter of each image frame in the first image frame sequence with the target brightness parameter of the applied functional mode, and adjust the image brightness of the image frame to output the second image frame sequence if the image brightness parameter of the image frame in the first image frame sequence is not matched with the target brightness parameter.

29. The visual control device according to embodiment 25, wherein the image brightness parameter is calculated by the image processing unit based on a predefined area of interest and weight value of each area of interest, wherein the weight value of the area of interest is associated with the functional mode corresponding to the image frame.

30. The visual control device according to embodiment 29, wherein the calculation of the image brightness parameter by the image processing unit includes:

dividing the image frame into blocks with the area of interest as a unit; and

calculating the image brightness parameter of the image frame based on a weight value corresponding to the position of each area of interest in the image.

31. The image processing device according to embodiment 29, wherein in a functional mode of obstacle avoidance or visual tracking, a weight value of a ground image area is higher than a weight value of an above-ground image area; in a functional mode of visual localization and mapping, a weight value of the ground image area is lower than a weight value of the above-ground image area; or in a visual docking mode, a weight value of a middle area of the image is higher than a weight value of a surrounding area of the image.

32. The visual control device according to embodiment 27, wherein the image processing unit is configured to adjust image brightness of each image frame through adjusting an image gain of each image frame in the first image frame sequence, and/or adjusting a brightness contrast of the corresponding image frame.

33. The visual control device according to embodiment 25, wherein the image processing unit is configured to perform at least one of image segmentation, image denoising, image color correction, and image resolution adjustment.

34. The visual control device according to embodiment 25, wherein each image frame in the second image frame sequence output by the image processing unit is arranged according to frame rate requirement corresponding to the respective function mode.

35. The visual control device according to embodiment 34, wherein a frame rate requirement of each functional mode for image corresponding to visual localization and mapping or visual scene understanding is not less than 2 frames per second; a frame rate requirement of each functional mode for image corresponding to obstacle avoidance or visual tracking is not less than 7 frames per second.

36. An image acquisition assembly, used in a mobile robot, including:

a vision acquisition device, configured to capture a first image frame sequence; and

the visual control device according to any one of embodiments 25 to 35, connected with the vision acquisition device and configured to output a second image frame sequence based on the first image frame sequence.

37. The image acquisition assembly according to embodiment 36, wherein the vision acquisition device includes an image sensor and a lens assembly, wherein the image sensor is connected with the lens assembly.

38. The image acquisition assembly according to embodiment 37, wherein the vision acquisition device further includes an infrared cut filter located between the image sensor and the lens assembly.

39. The image acquisition assembly according to embodiment 37, wherein the vision acquisition device further includes a light compensating lamp, the light compensating lamp is configured for light compensating when the light in the environment where the image acquisition assembly is located is insufficient.

40. A control method of a mobile robot, including the following steps:

receiving an image frame sequence, wherein the image frame sequence is output by an image processing chip according to embodiment 12, or through performing the image processing method according to any one of embodiments 13-24 by an image acquisition assembly, or by the visual control device according to any one of embodiments 25-34, or by the image acquisition assembly according to any one of embodiments 36-39; and

executing a corresponding functional mode correspondingly based on each image frame in the image frame sequence so that the mobile robot works according to the corresponding functional mode.

41. A control system of a mobile robot, wherein the mobile robot includes an image acquisition assembly, the control system including:

an interface device, configured to receive an image frame sequence output by the image acquisition assembly;

a memory, configured to store at least one program; and

a processor, connected with the interface device and the memory and configured to coordinate the interface device, the memory and the image acquisition assembly to execute and implement the control method according to embodiment 40 when invoking and executing the at least one program.

42. A mobile robot, including:

the image acquisition assembly according to any one of embodiments 36 to 39, configured to capture a first image frame sequence and output a second image frame sequence;

a movement device, configured to drive, in a controlled manner, the mobile robot to move in a corresponding functional mode;

a memory, configured to store acquired image frame sequences and at least one program; and

a processor, configured to execute the control method according to embodiment 40 when invoking the at least one program.

43. The mobile robot according to embodiment 42, wherein an angle between an optical axis direction of the image acquisition assembly and a forward movement direction of the mobile robot is 12° to 15°; and a horizontal field angle of the image acquisition assembly is 110° to 130°, and a vertical field angle of the monocular camera is 80° to 100°.

44. A computer readable storage medium storing at least one program which, when being invoked, executes the image processing method according to any one of embodiments 1 to 11, or 13 to 24, or executes the control method according to embodiment 40.

Based on the above description of the examples, the present application further provides various embodiments, specifically as follows.

45. A control method of a mobile robot, including the following steps:

acquiring a first image sequence in a forward movement direction in a first traveling state of the mobile robot;

maintaining the first traveling state when an obstacle is identified in at least one frame of image in the first image sequence; and

acquiring a second image sequence in the forward movement direction in the first traveling state, and controlling the mobile robot to move in a second traveling state when the same obstacle is identified in at least one frame of image in the second image sequence.

46. The control method according to embodiment 45, wherein a frame rate at which the first image frame sequence and the second image frame sequence are acquired is 7 to 12 frames per second.

47. The control method according to embodiment 45, wherein images in the first image frame sequence and the second image frame sequence contain ground image areas.

48. The control method according to embodiment 45, wherein the first image sequence and the second image sequence are extracted from image sequences output by an image acquisition assembly provided on the mobile robot; and parameters of images in the first image sequence and the second image sequence are different from parameters of images that are not extracted.

49. The control method according to embodiment 45, wherein an image classifier is used to identify whether an obstacle exists in the first image frame sequence and the second image frame sequence.

50. The control method according to embodiment 45, wherein the step of controlling the mobile robot to move in a second traveling state when the same obstacle is identified in at least one frame of image in the second image sequence includes:

performing visual tracking on at least one frame of image in the second image sequence according to the obstacle identified in the first image; and

controlling the mobile robot to move in the second traveling state when the existence of the same obstacle in the second image sequence is confirmed.

51. The control method according to embodiment 45, wherein before identifying at least one frame of image in the first image sequence and identifying at least one frame of image in the second image sequence, the method further includes a step of pre-processing the at least one frame of image.

52. The control method according to embodiment 51, wherein the pre-processing includes at least one processing of image segmentation, image contrast adjustment, and resolution adjustment.

53. The control method according to embodiment 45, wherein identifying at least one frame of image in the first image sequence and identifying at least one frame of image in the second image sequence includes the following step:

identifying a ground image area and an object image area in at least one frame of image and outputting an identification result based on image position information of the object image area relative to the ground image area.

54. The control method according to embodiment 53, wherein the step of identifying a ground image area includes: extracting ground feature information of the image, and determining the ground image area in the image based on the ground feature information; or determining the ground image area in the image based on a preset size condition.

55. The control method according to embodiment 45, wherein the first traveling state includes a first traveling speed, and the second traveling state includes a second traveling speed, wherein the second traveling speed is less than the first traveling speed; and/or the first traveling state includes a first traveling direction, and the second traveling state includes a second traveling direction, wherein the second traveling direction differs from the first traveling direction.

56. The control method according to embodiment 45, wherein the step of controlling the mobile robot to move in a second traveling state includes controlling the mobile robot to perform at least one of moving at a decelerated speed, moving in a steering manner, and braking.

57. The control method according to embodiment 45, further including a step of performing movement control on the mobile robot by detecting collision information between the mobile robot and the obstacle.

58. The control method according to embodiment 57, wherein the step of performing movement control on the mobile robot by detecting collision information between the mobile robot and the obstacle includes: controlling the mobile robot to pushing the obstacle to move when the collision information is detected.

59. A control system of a mobile robot, wherein the mobile robot includes an image acquisition assembly, the control system including:

an acquisition module, configured to acquire a first image sequence and a second image sequence in a forward movement direction in a first traveling state, wherein the first image sequence and the second image sequence are captured by the image acquisition assembly;

an image classifier, connected with the acquisition module and configured to identify at least one frame of image in the first image sequence and identify at least one frame of image in the second image sequence;

a state machine, connected with the image classifier and configured to control the mobile robot to move still in the first traveling state when an obstacle is identified in at least one frame of image in the first image sequence, and control the mobile robot to move in a second traveling state when the same obstacle is identified in at least one frame of image in the second image sequence.

60. A control system of a mobile robot, wherein the mobile robot includes an image acquisition assembly, the control system including:

an interface device, configured to receive images captured by the image acquisition assembly;

at least one memory, configured to store at least one program; and

at least one processor, connected with the interface device and the at least one memory, and configured to invoke and execute the at least one program and coordinate the interface device, the at least one memory and the image acquisition assembly to execute and implement the control method according to any one of embodiments 45-58.

61. A mobile robot, including:

an image acquisition assembly, configured to capture images in a forward movement direction of the mobile robot;

a movement device, configured to drive, in a controlled manner, the mobile robot to move; and

the control system according to embodiment 60, wherein the control system is configured to control the movement device to move according to control method executed therein.

62. The mobile robot according to embodiment 61, wherein the image acquisition assembly is obliquely arranged in front of the mobile robot so that the captured image includes a ground image area.

63. A computer readable storage medium storing at least one program which, when being invoked, executes and implements the control method according to any one of embodiments 45 to 58.

64. A cleaning robot, including:

a robot body with a chassis and a housing;

a movement device, arranged on the chassis and configured to drive the cleaning robot to move;

a cleaning device, arranged on the chassis and configured to clean a surface to be cleaned; and

an image acquisition assembly, arranged at the intersection of a top surface and a side surface of a front end of the housing, the image acquisition assembly including a monocular camera, an optical axis of the monocular camera is arranged in a tilted upward direction, wherein an angle between the optical axis of the monocular camera and a forward movement direction of the cleaning robot is 12° to 15°; and a horizontal field angle of the monocular camera is 110° to 130°, and a vertical field angle of the monocular camera is 80° to 100°.

65. The cleaning robot according to embodiment 64, wherein a focal length of the monocular camera is 8 cm to 12 cm.

66. The cleaning robot according to embodiment 64, further including a recessed structure, the recessed structure is arranged at the intersection of the top surface and side surface at the front end of the housing, the image acquisition assembly is arranged in the recessed structure.

67. The cleaning robot according to embodiment 64, further including a buffer assembly, the buffer assembly is arranged at the front end of the housing, the buffer assembly is provided with a recessed structure for accommodating the image acquisition assembly.

68. The cleaning robot according to embodiment 64, wherein the image acquisition assembly further includes:

a mounting seat; and

a camera base, arranged on the mounting seat, the camera base is provided with a camera mounting structure for mounting the monocular camera.

69. The cleaning robot according to embodiment 68, wherein the monocular camera includes a camera circuit board, an image sensor, and a lens assembly, wherein the camera circuit board is arranged on the mounting seat, and the image sensor is electrically connected to the camera circuit board.

70. The cleaning robot according to embodiment 69, wherein the monocular camera further includes an infrared cut filter located between the image sensor and the lens assembly.

71. The cleaning robot according to embodiment 69, wherein a protective cover plate is provided on the camera base, and a camera glass barrier corresponding to the lens assembly is provided on the protective cover plate.

72. The cleaning robot according to embodiment 69, wherein the image acquisition assembly further includes a light compensating lamp, and the camera base is provided with a light compensating lamp mounting structure for mounting the light compensating lamp.

73. The cleaning robot according to embodiment 72, wherein a protective cover plate is provided on the camera base, and a camera glass barrier corresponding to the lens assembly and a light compensating lamp glass barrier corresponding to the light compensating lamp are provided on the protective cover plate.

74. The cleaning robot according to embodiment 72, wherein the monocular camera and the light compensating lamp are arranged in a up-down direction of the camera base; or the monocular camera and the light compensating lamp are arranged in a left-right direction of the camera base.

75. The cleaning robot according to embodiment 72, wherein the light compensating lamp is a blue LED.

76. The cleaning robot according to embodiment 68, wherein the camera base is fixed to the mounting seat by locking attachment structure or clamping buckle structure.

77. The cleaning robot according to embodiment 68, wherein the camera circuit board is fixed to the mounting seat by locking attachment structure or clamping buckle structure.

78. The cleaning robot according to embodiment 68, wherein the mounting seat is mounted to/removed from the housing in a vertical direction or a horizontal direction.

79. The cleaning robot according to embodiment 68, wherein the mounting seat is fixed to the housing by locking attachment structure or clamping buckle structure.

80. The cleaning robot according to embodiment 68, wherein the camera circuit board is electrically connected to a main circuit board in the housing by a flexible circuit board.

81. The cleaning robot according to embodiment 64, wherein the image acquisition assembly includes an angle adjustment mechanism for adjusting a tilt angle of the monocular camera.

82. The cleaning robot according to embodiment 64, further including a waterproof assembly, the waterproof assembly is arranged between the image acquisition assembly and the housing.

The above embodiments are merely illustrative of the principles of the present application and effects thereof, and are not intended to limit the present application. Any person skilled in the art can modify or change the above embodiments without departing from the spirit and scope of the present application. Therefore, all equivalent modifications or changes made by those skilled in the art without departing from the spirit and technical ideas disclosed in the present application are still encompassed within the scope of the claims of the present application.

1-10. (canceled)

11. A method for controlling a mobile robot, comprising the following steps:
distributing each received image frame to a corresponding functional mode for use correspondingly, wherein the image frame is output through performing a method for image processing by an image acquisition assembly provided on a mobile robot; and
executing the corresponding functional mode correspondingly based on each image frame so that the mobile robot works according to the corresponding functional mode;
wherein, the method for image processing by the image acquisition assembly comprises the following steps:
capturing an image frame sequence; and
outputting a corresponding image frame for use in at least one functional mode of the mobile robot sequentially based on the image frame sequence, wherein a frame rate of the output image frame for use in the same functional mode is set based on a frame rate requirement of each functional mode for image.

12. A mobile robot, comprising:
an image acquisition assembly; wherein, the image acquisition assembly comprises:
a vision acquisition device, configured to capture images;
a control unit, connected with the vision acquisition device and configured to control the vision acquisition device so that the images captured by the vision acquisition device are output in an image frame sequence; and
an image processing unit, connected with the vision acquisition device, configured to output a corresponding image frame for use in at least one functional mode of the mobile robot sequentially based on the image frame sequence, wherein a frame rate of the output image frame for use in the same functional mode is set based on a frame rate requirement of each functional mode for image;
a movement device, configured to take the mobile robot to work in a corresponding functional mode in a controlled manner;
a memory, configured to store the image frame sequence and at least one program; and
a processor, configured to execute the at least one program, wherein the at least one program is configured to perform the steps of:
distributing each received image frame to a corresponding functional mode for use correspondingly, wherein the image frame is output through performing image processing by an image acquisition assembly provided on a mobile robot; and
executing the corresponding functional mode correspondingly based on each image frame so that the mobile robot works according to the corresponding functional mode;
wherein, the performing image processing by the image acquisition assembly comprises the following steps:
capturing an image frame sequence; and
outputting a corresponding image frame for use in at least one functional mode of the mobile robot sequentially based on the image frame sequence, wherein a frame rate of the output image frame for use in the same functional mode is set based on a frame rate requirement of each functional mode for image.

13. The mobile robot of claim 12, wherein, the vision acquisition device comprises an image sensor and a lens assembly, wherein the image sensor is connected with the lens assembly.

14. The mobile robot of claim 13, wherein, the vision acquisition device further comprises an infrared cut filter, the infrared cut filter is positioned between the image sensor and the lens assembly.

15. The mobile robot of claim 13, wherein, the vision acquisition device further comprises a light compensating lamp, the light compensating lamp is configured to compensate light when the light in the environment where the image acquisition assembly is located is insufficient.

16. The mobile robot of claim 12, wherein, an angle between an optical axis direction of the image acquisition assembly and a forward movement direction of the mobile robot is 12° to 15°; and a horizontal field angle of the image acquisition assembly is 110° to 130°, and a vertical field angle of the image acquisition assembly is 80° to 100°.

17. The mobile robot of claim 12, wherein, the time interval between the output adjacent frame images is uniform.

18. The mobile robot of claim 12, wherein, a horizontal field angle with which the image acquisition assembly captures the image frame sequence is 110° to 130° and a vertical field angle with which the image acquisition assembly captures the image frame sequence is 80° to 100°.

19. The mobile robot of claim 12, wherein, the functional mode comprises at least one of visual localization and mapping, obstacle avoidance, visual docking, visual scene understanding, and visual tracking.

20. The mobile robot of claim 19, wherein, an image frame rate corresponding to the visual localization and mapping or visual scene understanding is not less than 2 frames per second; an image frame rate corresponding to the obstacle avoidance or visual tracking is not less than 7 frames per second.

21. The mobile robot of claim 12, further comprising a step of acquiring a control instruction reflecting a power mode; and
the step of outputting a corresponding image frame for use in at least one functional mode of the mobile robot sequentially based on the image frame sequence comprises: adjusting time interval between each output frame of images based on the control instruction.

22. The mobile robot of claim 12, further comprising a step of performing image brightness processing on the image frame sequence according to target brightness parameters of the functional mode and outputting image frames based on a time series.

23. The mobile robot of claim 22, wherein, a manner of performing image brightness processing on the image frame sequence comprises: adjusting an image gain of a corresponding image frame, and/or adjusting a brightness contrast of a corresponding image frame.

24. The mobile robot of claim 12, further comprising a step of performing at least one of image segmentation, image denoising, image color correction, and image resolution adjustment on the image frame sequence.

25. The mobile robot of claim 12, wherein, the step of capturing an image frame sequence comprises: adjusting an exposure during photographing automatically according to the light in the environment where the image acquisition assembly is located.

26. The method for controlling a mobile robot of claim 11, wherein, the time interval between the output adjacent frame images is uniform.

27. The method for controlling a mobile robot of claim 11, wherein, a horizontal field angle with which the image acquisition assembly captures the image frame sequence is 110° to 130° and a vertical field angle with which the image acquisition assembly captures the image frame sequence is 80° to 100°.

28. The method for controlling a mobile robot of claim 11, wherein, the functional mode comprises at least one of visual localization and mapping, obstacle avoidance, visual docking, visual scene understanding, and visual tracking.

29. The method for controlling mobile robot of claim 28, wherein, an image frame rate corresponding to the visual localization and mapping or visual scene understanding is not less than 2 frames per second; an image frame rate corresponding to the obstacle avoidance or visual tracking is not less than 7 frames per second.

30. The method for controlling a mobile robot of claim 11, further comprising a step of acquiring a control instruction reflecting a power mode; and
the step of outputting a corresponding image frame for use in at least one functional mode of the mobile robot sequentially based on the image frame sequence comprises: adjusting time interval between each output frame of images based on the control instruction.

31. The method for controlling a mobile robot of claim 11, further comprising a step of performing image brightness processing on the image frame sequence according to target brightness parameters of the functional mode and outputting image frames based on a time series.

32. The method for controlling mobile robot of claim 31, wherein, a manner of performing image brightness processing on the image frame sequence comprises: adjusting an image gain of a corresponding image frame, and/or adjusting a brightness contrast of a corresponding image frame.

33. The method for controlling a mobile robot of claim 11, further comprising a step of performing at least one of image segmentation, image denoising, image color correction, and image resolution adjustment on the image frame sequence.

34. The method for controlling a mobile robot of claim 11, wherein, the step of capturing an image frame sequence comprises: adjusting an exposure during photographing automatically according to the light in the environment where the image acquisition assembly is located.
